(19) United States
(12) Patent Application Publication
(10) Pub. No.: US 2004/0057448 A1
(43) Pub. Date: Mar. 25, 2004

(54) Information processing system, information processing apparatus, and information processing method

(75) Inventor: Atsushi Nakamura, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/653,962

(22) Filed: Sep. 4, 2003

(30) Foreign Application Priority Data
Sep. 5, 2002 (JP) 2002-260396

(51) Int. Cl. H04L 12/54; H04J 3/02

(52) U.S. Cl. 370/428; 370/462

(57) ABSTRACT

There is disclosed a system which makes efficient data transfer using two channels of an IEEE1394 bus. A system of this invention is an information processing system including first and second devices, wherein the first device comprises transmission means for transmitting one request which designates a plurality of data storage areas to the second device, the second device comprises completion notifying means for notifying the first device of completion of a data communication for one of the plurality of data storage areas, and in accordance with the notification of completion of the data communication for one of the plurality of data storage areas, the transmission means transmits one request which designates a data storage area, a data communication for which is not complete, and a new data storage area for the data storage area, the data communication for which is complete, to the second device.

### FIELD OF THE INVENTION

The present invention relates to an information processing system connected via an interface such as IEEE1394 or the like, an information processing apparatus, and an information processing method.

### BACKGROUND OF THE INVENTION

Upon establishing one-to-one connection and communications between a host and device via various interfaces such as Centronics, USB, IEEE1394, and the like, a plurality of logical channel connections are established between the host and device in one session of a communication protocol so as to control various functions of the device, and data transfer is made for each channel.

SBP (Serial Bus Protocol)-2 itself as a data communication protocol on IEEE1394 has a mechanism for making a one-way half-duplex data communication using a one-way single data channel since one ORB (operation request block) as a unit of data transfer refers to one data buffer in one logical unit (LUN), and it is difficult to implement a plurality of logical channels. In consideration of such drawback, SBP-3 as a functionally expanded version of SBP-2, whose specifications are currently being designed, has been expanded to implement two data transfer channels per LUN since one ORB as a data transfer unit in the LUN can refer to two data buffers.

However, in data transfer of SBP-3, since the flow control of two data transfer channels is made for respective ORBs, if either of the data transfer channels cannot transmit/receive data for some reason or if data transfer in either of the data transfer channels is slower than the other channel, the channel that allows normal or faster transfer is influenced by the other channel.

This is because even when access to one data buffer is normally terminated, a completion message for that ORB cannot be sent to the initiator of SBP-3 if access to the other data buffer is not complete, and data transfer as the LUN is delayed.

### SUMMARY OF THE INVENTION

The present invention has been made to solve the conventional problems, and a system according to the present invention is directed to an information processing system including first and second devices,

wherein the first device comprises transmission means for transmitting one request which designates a plurality of data storage areas to the second device,

the second device comprises completion notifying means for notifying the first device of completion of a data communication for one of the plurality of data storage areas, and

in accordance with the notification of completion of the data communication for one of the plurality of data storage areas, the transmission means transmits one request which designates a data storage area, a data communication for which is not complete, and a new data storage area for the data storage area, the data communication for which is complete, to the second device.

In order to achieve the above object, a method according to the present invention is directed to a communication method between two devices, comprising:

a transmission step of transmitting one request which designates a plurality of data storage areas;

a completion notifying step of notifying completion when a data communication for one of the plurality of data storage areas designated by the request is complete; and

a transmission step of, in accordance with the notification of completion of the data communication for one of the plurality of data storage areas, transmitting one request which designates a data storage area, a data communication for which is not complete, and a new data storage area for the data storage area, the data communication for which is complete.

The two devices are connected via a communication control bus complying with IEEE1394.

The transmission step includes a step of transmitting a request block which contains a plurality of pieces of identification information respectively indicating the plurality of data storage areas, and commands respectively for the plurality of data storage areas.

The method further comprises a data communication step of writing data on the data storage area designated by the request or reading data from the data storage area designated by the request.

In order to achieve the above object, an apparatus according to the present invention is directed to an information processing apparatus which can communicate with another device, comprising:

a unit that transmits one request which designates a plurality of data storage areas;

a unit that receives, from the other device, a completion message indicating completion of a data communication for one of the plurality of data storage areas; and

a unit that transmits, on the basis of the completion message, one request which designates a data storage area, a data communication for which is not complete, and a new data storage area for the data storage area, the data communication for which is complete.

The transmission unit transmits a request block which contain a plurality of pieces of identification information respectively indicating the plurality of data storage areas, and commands respectively for the plurality of data storage areas.

In order to achieve the above object, an apparatus according to the present invention is directed to an information processing apparatus which can communicate with another device, comprising:

a unit that receives one request which designates a plurality of data storage areas; and

a completion notifying unit that notifies completion of a data communication for one of the plurality of data storage areas.

The apparatus further comprises a data communication unit that transmits data to the other device so as to write data in the data storage area designated by the request or receiving data from the other device so as to read data from the data storage area designated by the request.

When data is written in one of the plurality of data storage areas or data is read out from the data storage area, the completion notifying unit notifies completion of a data communication for that data storage area.

The apparatus further comprises a determination unit that determines on the basis of a plurality of pieces of identification information respectively indicating the plurality of data storage areas whether or not a data buffer has been designated by the previously received request.

In order to achieve the above object, a method according to the present invention is directed to a communication method in an information processing apparatus which can communicate with another device, comprising:

transmitting one request which designates a plurality of data storage areas to the other device;

receiving, from the other device, a completion message indicating completion of a data communication for one of the plurality of data storage areas; and

transmitting, on the basis of the completion message, one request which designates a data storage area, a data communication for which is not complete, and a new data storage area for the data storage area, the data communication for which is complete.

In order to achieve the above object, a method according to the present invention is directed to a communication method in an information processing apparatus which can communicate with another device, comprising:

receiving, from the other device, one request which designates a plurality of data storage areas;

making a data communication for one of the plurality of data storage areas; and

notifying the other device of completion of a data communication for one of the plurality of data storage areas.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the arrangement of a host-printer communication system according to the present invention;

FIG. 2 is a diagram showing the arrangement of a 1394 serial bus network;

FIG. 3 shows the building components of a 1394 serial bus according to the present invention;

FIG. 4 shows services that can be provided by a link layer of the 1394 serial bus according to the present invention;

FIG. 5 shows services that can be provided by a transaction layer of the 1394 serial bus according to the present invention;

FIG. 6 is a view for explaining an address space in a 1394 interface;

FIG. 7 shows the addresses and functions of information stored in a CSR core register in the 1394 interface;

FIG. 8 shows the addresses and functions of information stored in a serial bus register in the 1394 interface;

FIG. 9 shows the minimal format of a configuration ROM in the 1394 interface;

FIG. 10 shows the general format of a configuration ROM in the 1394 interface;

FIG. 11 shows the addresses and functions of information stored in a serial bus device register in the 1394 interface;

FIG. 12 is a sectional view of a communication cable complying with IEEE1394;

FIG. 13 is a chart for explaining a DS-link encoding scheme;

FIG. 14 is a diagram showing a basic sequence from the beginning of a bus reset until a node ID assignment process;

FIG. 15 is a flow chart showing a basic sequence from the beginning of a bus reset until a node ID assignment process;

FIG. 16 is a flow chart showing a basic sequence from the beginning of a bus reset until a node ID assignment process;

FIG. 17 is a flow chart for explaining the process in step S1505 shown in FIG. 15 (i.e., a process for automatically assigning node IDs of respective nodes) in detail;

FIG. 18 shows the format of a self ID packet in the 1394 interface;

FIGS. 19A and 19B are diagrams for explaining arbitration in a 1394 network;

FIG. 20 is a chart for explaining a case in which isochronous and asynchronous transfer modes mix in one communication cycle;

FIG. 21 shows the format of a communication packet transferred based on the isochronous transfer mode;

FIG. 22 shows the packet format of asynchronous transfer according to the present invention;

FIG. 23 shows ORB types in SBP-2;

FIG. 24 shows the format of a command block ORB in SBP-2;

FIG. 25 shows the format of a management ORB in SBP-2;

FIG. 26 shows the link list of command block ORBs in SBP-2;

FIG. 27 shows direct access to a data buffer in SBP-2;

FIG. 28 shows use of a page table in SBP-2;

FIG. 29 shows the format of a status FIFO in SBP-2;

FIG. 30 is a diagram showing a login operation in SBP-2;

FIG. 31 is a diagram showing the first operation of task execution in SBP-2;

FIG. 32 is a diagram showing the operation of a command ORB in SBP-2;

FIG. 33 is a diagram showing the operation of a command ORB in SBP-3;

FIG. 34 shows the format of a command block ORB in SBP-3;

FIG. 35 is a block diagram of a printer-host IEEE interface block in this embodiment;

FIG. 36 shows a configuration ROM of a printer in this embodiment;

FIG. 37 shows a 1394 address space of the printer in this embodiment;

FIG. 38 shows a core CSR register of the printer in this embodiment;

FIG. 39 shows the format of a status FIFO defined by a printer control communication command protocol used between the printer and host in this embodiment;

FIG. 40 shows the format of a command ORB defined by the printer control communication command protocol used between the printer and host in this embodiment;

FIG. 41 is a diagram showing the process of the first ORB list of the operations in the embodiment of the printer control communication command protocol used between the printer and host in this embodiment; and

FIG. 42 is a diagram showing the process of the second ORB list of the operations in the embodiment of the printer control communication command protocol used between the printer and host in this embodiment.

### DETAILED DESCRIPTION OF THE PREFERRED EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

(First Embodiment)

Prior to a description of an information processing system according to the first embodiment of the present invention, a technical overview of IEEE1394 will be explained.

<Technical Overview of IEEE1394>

An overview of the IEEE1394-1995 standard technology which is applied to a digital interface of this embodiment will be briefly explained below. Note that details of the IEEE1394-1995 standard (to be referred to as the IEEE1394 standard hereinafter) are described in “IEEE Standard for a High Performance Serial Bus” published by IEEE (The Institute of Electrical and Electronics Engineers, Inc.) on Aug. 30, 1996.

(1) Overview

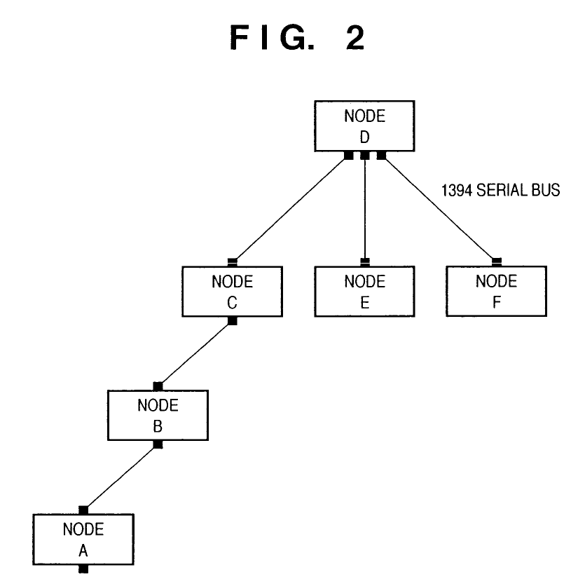

FIG. 2 shows an example of a communication system (to be referred to as a 1394 network hereinafter) constituted by nodes (devices) each comprising a digital interface (to be referred to as a 1394 interface hereinafter) complying with the IEEE1394 standard. The 1394 network forms a bus network that can communicate serial data.

Referring to FIG. 2, nodes A to F are connected via communication cables complying with the IEEE1394 standard. These nodes A to F are, for example, electronic devices such as a PC (Personal Computer), digital VTR (Video Tape Recorder), DVD (Digital Video Disc) player, digital camera, hard disk, monitor, and the like.

The connection scheme of the 1394 network includes a daisy-chain scheme and node branch scheme, and has high degree of freedom in connection.

In the 1394 network, for example, when an existing device is removed, a new device is added, or the power switch of an existing device is turned on/off, a bus reset is automatically executed. By executing the bus reset, the 1394 network can automatically recognize a new connection configuration, and can automatically assign ID information to respective devices. With this function, the 1394 network can always recognize the connection configuration of the network.

The 1394 network has a function of relaying data transferred from another device. With this function, all devices can recognize the operation state of the bus.

The 1394 network has a so-called Plug & Play function. With this function, a device can automatically be recognized only upon connecting it without turning off the power switches of all the devices.

The 1394 network is compatible to data transfer rates of 100/200/400 Mbps. Since a device having a higher data transfer rate can support a lower data transfer rate, devices corresponding to different data transfer rates can be connected to each other.

Furthermore, the 1394 network is compatible to two different data transfer modes (i.e., asynchronous transfer mode and isochronous transfer mode).

The asynchronous transfer mode is effective when data is required to be asynchronously transferred as needed (i.e., a control signal, data file, or the like). The isochronous transfer mode is effective when data of a given size is required to be continuously transferred at a constant data rate (i.e., video data, audio data, or the like).

The asynchronous and isochronous transfer modes can mix within one communication cycle (normally, one cycle=125 μs). Each transfer mode is executed after a cycle start packet (to be abbreviated as CSP hereinafter) indicating the start of a cycle is transferred.

Note that the isochronous transfer mode has higher priority than the asynchronous transfer mode during each communication cycle period. The transfer frequency band of the isochronous transfer mode is guaranteed within each communication cycle.

(2) Architecture

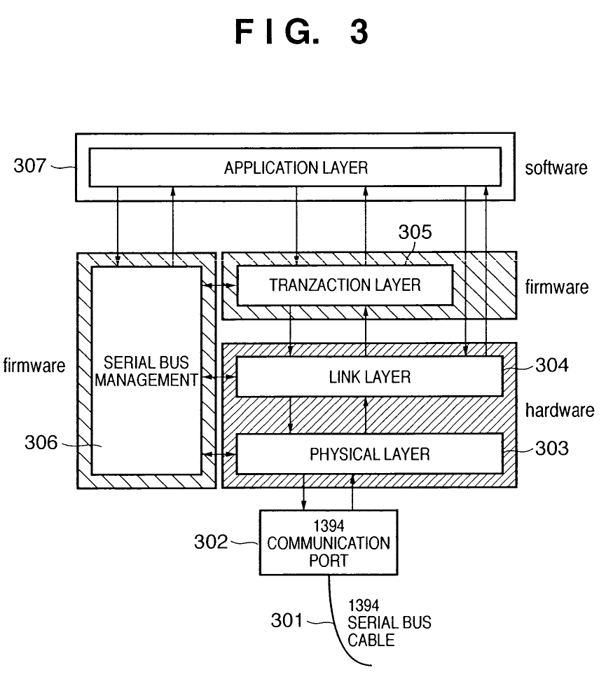

The building components of a 1394 interface will be explained below using FIG. 3.

The IEEE1394 interface functionally consists of a plurality of layers. In FIG. 3, the IEEE1394 interface is connected to that of another node via a communication cable 301 complying with the IEEE1394 standard. The IEEE1394 interface has at least one communication port 302, which is connected to a physical layer 303 included in a hardware block.

In FIG. 3, the hardware block comprises the physical layer 303 and a link layer 304. The physical layer 303 attains physical/electrical interfaces with another node, detection of a bus reset, a process executed upon detection of the bus reset, encoding/decoding of input/output signals, arbitration of the right to use a bus, and the like. The link layer 304 performs generation and exchange of communication packets, control of a cycle timer, and the like.

In FIG. 3, a firmware block includes a transaction layer 305 and serial bus management 306. The transaction layer 305 manages the asynchronous transfer mode to provide various transactions (read, write, lock). The serial bus management 306 provides a function of performing control of the self node, management of the connection state of the self node, management of ID information of the self node, resource management of the serial bus network, and the like on the basis of a CSR architecture (to be described later).

The aforementioned hardware and firmware blocks essentially configure the 1394 interface. Note that this basic configuration is specified by the IEEE1394 standard.

Note that an application layer 307 included in a software block differs depending on the application software used, and controls data communications on the network. For example, in case of moving image data of a digital VTR, the application layer is specified by a communication protocol such as the AV/C protocol or the like.

(2-1) Link Layer 304

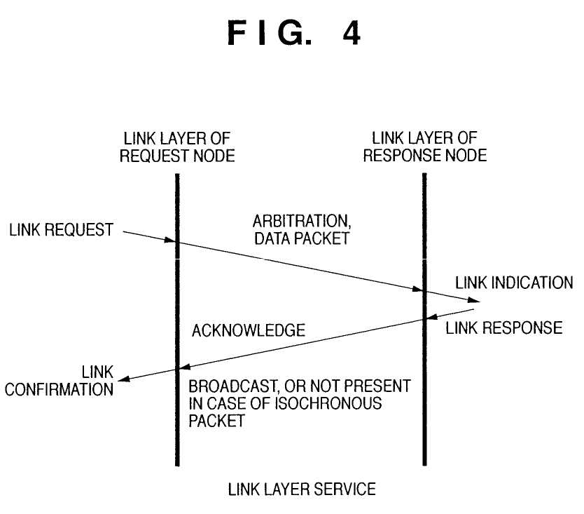

FIG. 4 shows services that the link layer 304 can provide. In FIG. 4, the link layer 304 provides the following four services: \mathring{1} a link request that requests transfer of a predetermined packet of a response node (LK_DATA.request), \mathring{2} a link indication that informs a response node of reception of a predetermined packet (LK_DATA.indication), \mathring{3} a link response which indicates that an acknowledge from a response node is received (LK_DATA.response), and \mathring{4} a link confirmation which confirms an acknowledge from a request node (LK_DATA.confirmation). Note that no link response (LK_DATA.response) is present in case of broadcast communications and transfer of isochronous packets.

The link layer 304 implements the aforementioned two different transfer modes, i.e., the asynchronous and isochronous transfer modes on the basis of the aforementioned services.

(2-2) Transaction Layer 305

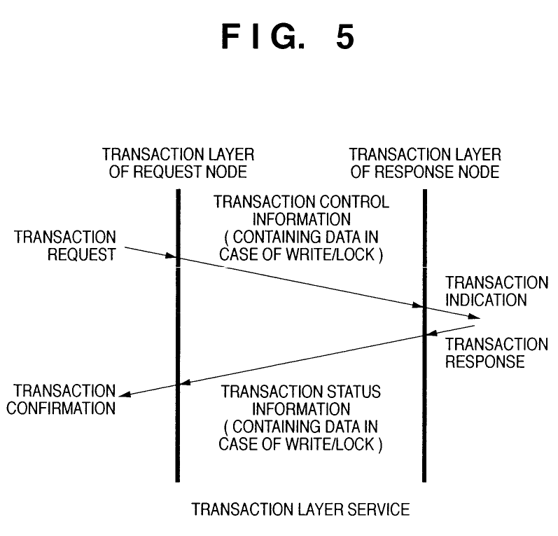

FIG. 5 shows services that the transaction layer 305 can provide. In FIG. 5, the transaction layer 305 provides the following four services: \mathring{1} a transaction request that requests a predetermined transaction of a response node (TR_DATA.request), \mathring{2} a transaction indication that informs a response node of reception of a predetermined transaction request (TR_DATA.indication), \mathring{3} a transaction response indicating that status information (containing data in case of write/lock) has been received from a response node (TR_DATA.response), and \mathring{4} a transaction confirmation that confirms status information from a request node (TR_DATA.confirmation).

The transaction layer 305 manages asynchronous transfer on the basis of the aforementioned services, and implements the following three different transactions, i.e., \mathring{1} read transaction, \mathring{2} write transaction, and \mathring{3} lock transaction.

In read transaction \mathring{1}, a request node reads information stored at a specific address of a response node.

In write transaction \mathring{2}, a request node writes predetermined information at a specific address of a response node.

In lock transaction \mathring{3}, a request node transfers reference data and update data to a response node, compares the reference data with information at a specific address of the response node, and updates the information at the specific address with the update data in accordance with the comparison result.

(2-3) Serial Bus Management 306

The serial bus management 306 can provide the following three functions: \mathring{1} node control, \mathring{2} an isochronous resource manager (to be abbreviated as IRM hereinafter), and \mathring{3} a bus manager.

Node control \mathring{1} provides a function of managing the aforementioned layers to manage asynchronous transfer executed with another node.

IRM \mathring{2} provides a function of managing isochronous transfer executed with another node. More specifically, the IRM manages information required to assign the transfer band width and channel number, and provides such information to another node.

Only one IRM is present on the local bus, and is dynamically selected from candidates (nodes having the IRM function) every bus reset. The IRM may provide some of functions (management of the connection configuration, power supply management, management of rate information, and the like) that the bus manager (to be described below) can provide.

Bus manager \mathring{3} has the IRM function, and provides higher-level bus management functions than the IRM. More specifically, the bus manager has functions of performing higher-level power supply management (that manages information indicating whether or not electric power can be supplied via a communication cable, whether or not power supply is required, and so forth for respective nodes), higher-level management of rate information (that manages the maximum transfer rate among nodes), higher-level management of the connection configuration (that generates a topology map), optimization of a bus based on such management information, and the like, and providing such information to another node.

Also, the bus manager can provide services for controlling a serial bus network to an application. Note that the services include a serial bus control request (SB_CONTROL.request), serial bus event control confirmation (SB_CONTROL.confirmation), serial bus event indication (SB_CONTROL.indication), and the like.

SB_CONTROL.request is a service that allows an application to request a bus reset. SB_CONTROL.confirmation is a service that confirms SB_CONTROL.request with respect to an application. SB_CONTROL.indication is a service that informs an application of an event that occurs asynchronously.

(3) Address Designation

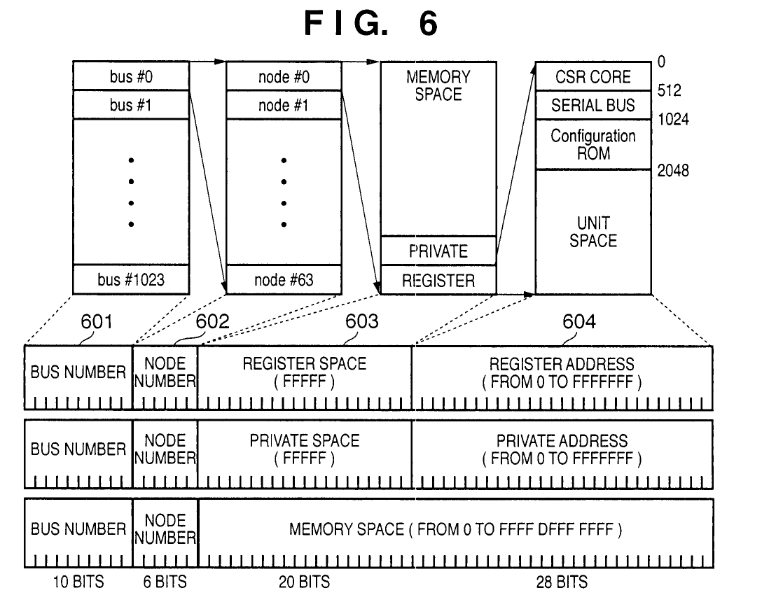

FIG. 6 is a view for explaining the address space in the 1394 interface. Note that the 1394 interface specifies a 64-bit wide address space according to the CSR (Command and Status Register) architecture complying with ISO/IEC13213:1994.

In FIG. 6, the first 10-bit field 601 is used to store an ID number for designating a predetermined bus, and the next 6-bit field 602 is used to store an ID number for designating a predetermined device (node). These upper 16 bits are called a “node ID”, and each node identifies another node on the basis of this node ID. Each node can make communications while identifying a partner node using this node ID.

A field consisting of the remaining 48 bits designates an address space (256-Mbyte structure) of each node. A 20-bit field 603 of these bits designates a plurality of areas which form the address space.

In the field 603, a space “0 to 0xFFFFD” is called a memory space. A space “0xFFFFE” is called a private space that each node can freely use. Also, a space “0xFFFFE” is called a register space which stores information common to nodes connected to the bus. Each node can manage inter-node communications using information in the register space.

The last 28-bit field 604 designates an address where information common or unique to each node is stored.

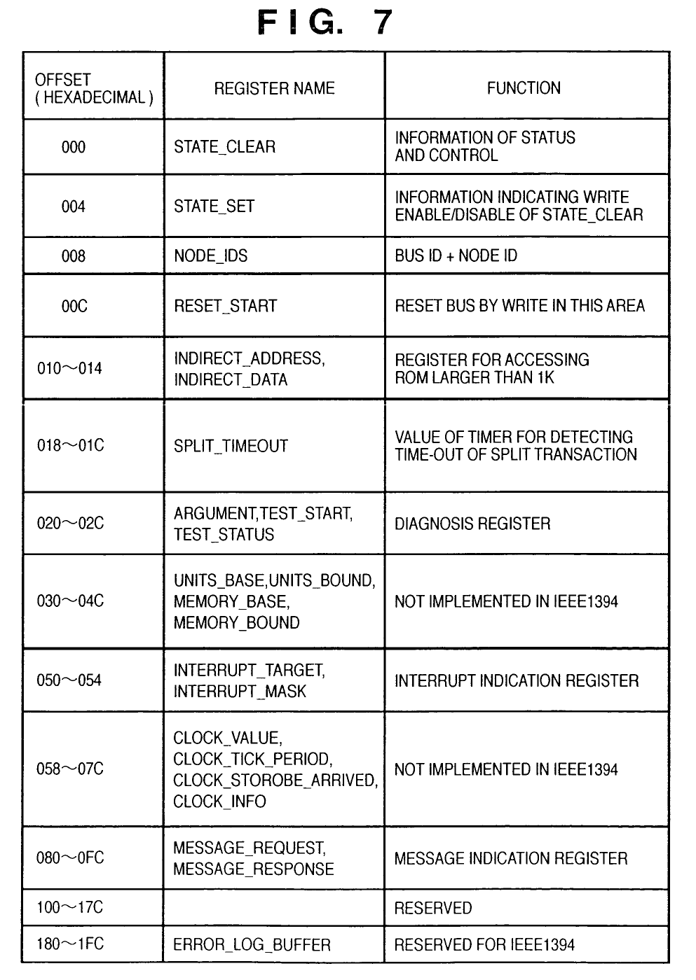

For example, in the register space, the first 512 bytes are used for a core (CSR core) register of the CSR architecture. FIG. 7 shows the addresses and functions of information stored in the CSR core register. Offsets in FIG. 7 indicate relative positions from “0xFFFFF0000000”.

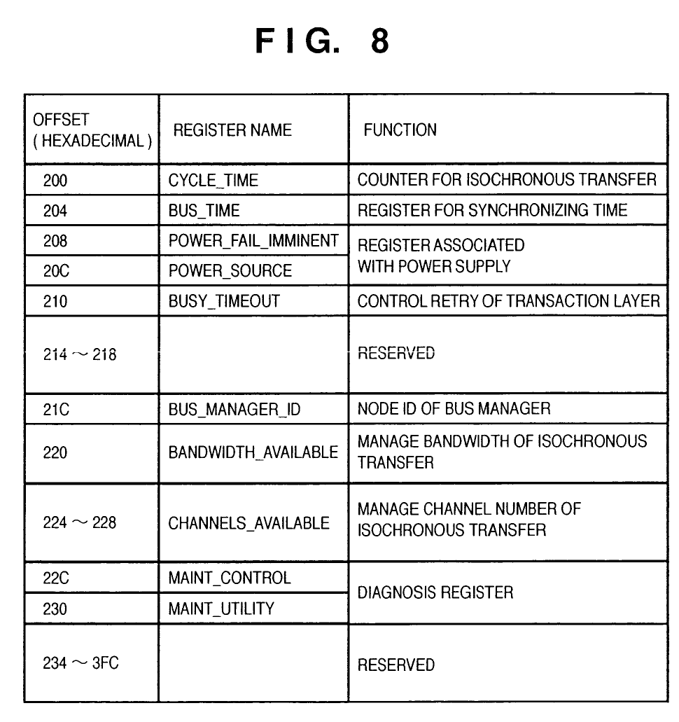

The next 512 bytes in FIG. 6 are used for a serial bus register. FIG. 8 shows the addresses and functions of information stored in the serial bus register. Offsets in FIG. 8 indicate relative positions from “0xFFFFF0000200”.

The next 1024 bytes in FIG. 6 are used for a configuration ROM.

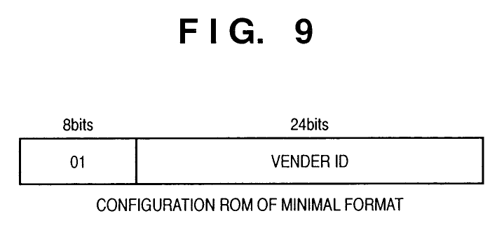

The configuration ROM has a minimal format or general format, and is allocated from “0xFFFFF0000400”. FIG. 9 shows an example of the minimal format of the configuration ROM. In FIG. 9, a vendor ID is a 24-bit numerical value uniquely assigned by IEEE to each vendor.

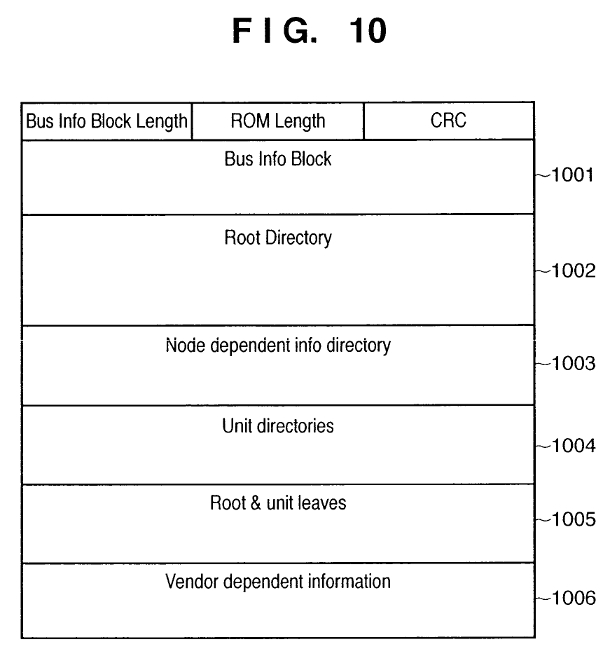

FIG. 10 shows the general format of the configuration ROM. In FIG. 10, the aforementioned vendor ID is stored in a root directory 1002. A bus info block 1001 and root leaf 1005 can hold a node unique ID as unique ID information that identifies each node.

Note that the node unique ID specifies a unique ID that can specify one node independently of the manufacturers and models. The node unique ID consists of 64 bits, the upper 24 bits of which indicate the aforementioned vendor ID, and the lower 48 bits of which indicate information (e.g., the manufacture number of the node or the like) that the manufacturer of each node can freely set. Note that the node unique ID is used to successively recognize a specific node before and after a bus reset.

In FIG. 10, the root directory 1002 can hold information which pertains to the basic functions of the node. Details of the function information are stored in unit directories 1004 as subdirectories offset from the root directory 1002. The unit directories 1004 store information which pertains to software units that the node supports. More specifically, information that pertains to a data transfer protocol used to make a data communication between nodes, a command set which defines a predetermined communication procedure, and the like is held.

Also, in FIG. 10, a node dependent info directory 1003 can hold information unique to a device. The node dependent info directory 1003 is offset by the root directory 1002.

Furthermore, in FIG. 10, vendor dependent information 1006 can hold information unique to a vendor which manufactured or vended the node.

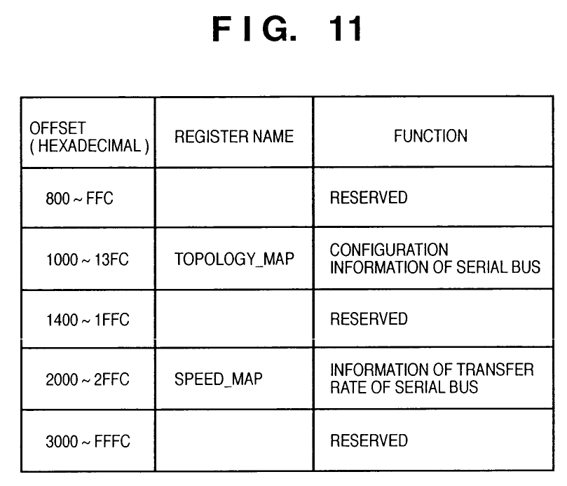

The remaining area is called a unit space, which designates an address where information unique to each node, for example, identification information (company name, model name, or the like) of each device, a use condition, or the like is stored. FIG. 11 shows the addresses and functions of information stored in a serial bus device register of the unit space. Offsets in FIG. 11 indicate relative positions from “0xFFFFF0000800”.

Note that each node should use the first 2048 bytes of the register space to simplify the design of disparate bus systems. That is, the register space is preferably made up of the CSR core register, serial bus register, configuration ROM, and the first 2048 bytes of the unit space, i.e., a total of 4096 bytes.

(4) Structure of Communication Cable

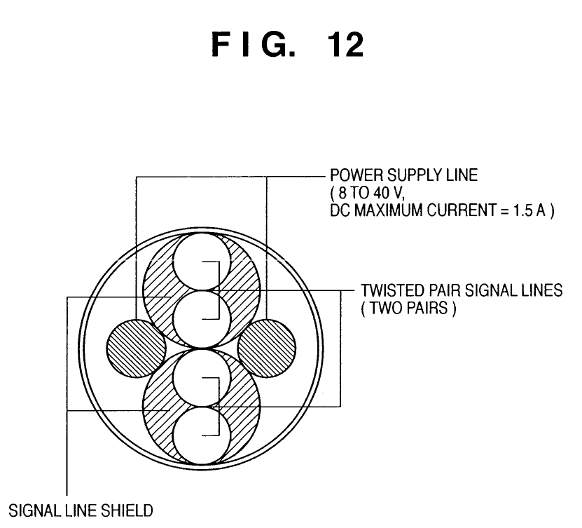

FIG. 12 is a sectional view of a communication cable complying with the IEEE1394 standard.

The communication cable is comprised of two pairs of twisted pair signal lines, and power supply lines. By providing the power supply lines, the 1394 interface can supply electric power even to a device the main power supply of which is OFF, a device whose electric power has dropped due to some failure, and the like. Note that the power supply voltage flowing in the power supply line is specified to fall within the range of 8 to 40 V, and the maximum current is specified to be DC 1.5 A.

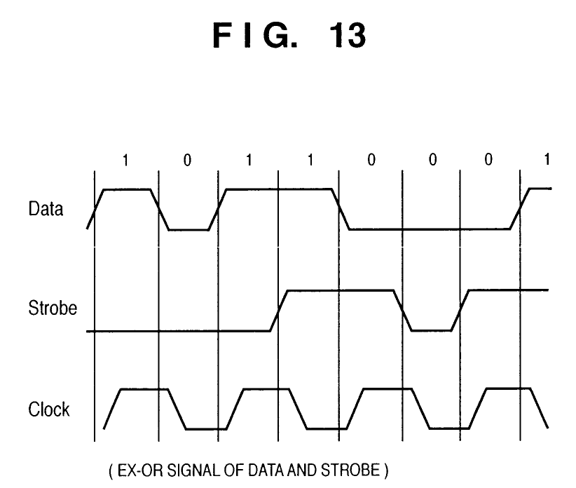

The two pairs of twisted pair signal lines transfer information signals encoded by the DS-Link (Data/Strobe Link) encoding scheme. FIG. 13 is a chart for explaining the DS-Link encoding scheme.

The DS-Link encoding scheme is suited to high-speed serial data communications, and requires two pairs of twisted pair lines. One pair of twisted pair lines send a data signal, and the other pair of twisted pair lines send a strobe signal. The receiving side can reclaim clocks by EX-ORing the data and strobe signals received from the two pairs of signal lines.

Using the DS-Link encoding scheme, the 1394 interface can obtain the following merits: \mathring{1} the transfer efficiency is higher than other encoding schemes; \mathring{2} the need for a PLL circuit can be obviated to reduce the circuit scale of a controller LSI; and \mathring{3} since no information indicating an idle state need be sent, a transceiver circuit can be easily set in a sleep state to reduce consumption power.

(5) Bus Reset

The 1394 interface of each node can automatically detect a change in connection configuration of the network. In this case, the 1394 network executes a process called a bus reset in the following procedure. Note that the change in connection configuration can be detected by a change in bias voltage applied to the communication port of each node.

A node that has detected a change in connection configuration of the network (e.g., an increase/decrease in the number of nodes due to insertion/removal of a node, the power ON/OFF of a node, or the like), or a node that must recognize a new connection configuration outputs a bus reset signal onto the bus via the 1394 interface.

The 1394 interface of a node that received the bus reset signal reports generation of a bus reset to its own link layer 304, and transfers that bus reset signal to another node. Upon receiving the bus reset signal, the other node clears the connection configuration of the network recognized so far, and node IDs assigned to the respective devices. After all the nodes detect the bus reset signal, each node automatically executes an initialization process (i.e., recognition of a new connection configuration and assignment of new node IDs) upon bus reset.

Note that the bus reset can be launched when the application layer 307 directly issues a command to the physical layer 303 under the control of the host, in addition to detection of the change in connection configuration.

Upon launching the bus reset, data transfer is temporarily interrupted, and is restarted under a new network after the end of the initialization process upon bus reset.

(6) Sequence After Bus Reset is Launched

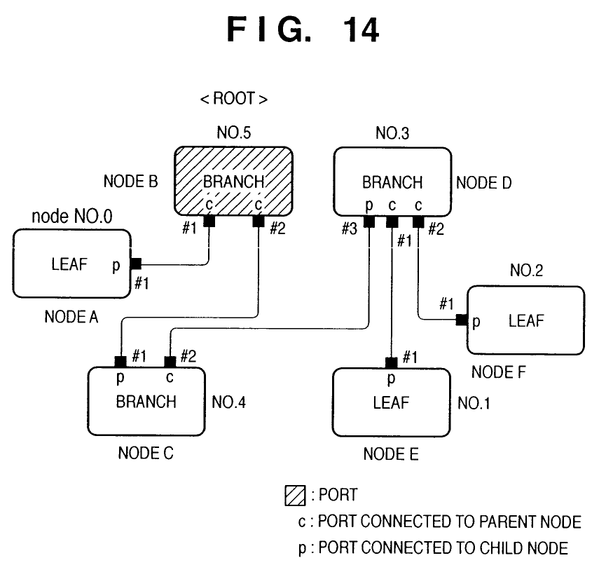

After a bus reset is launched, the 1394 interface of each node automatically recognizes a new connection configuration, and assigns new node IDs. The basic sequence from the beginning of the bus reset until assignment of node IDs will be explained below using FIGS. 14 to 16.

FIG. 14 is a view for explaining the state after the bus reset is launched in the 1394 network shown in FIG. 2.

Referring to FIG. 14, node A comprises one communication port; node B two ports; node C two ports; node D three ports; node E one port; and node F one port. The communication ports of those nodes are assigned port numbers to identify these ports.

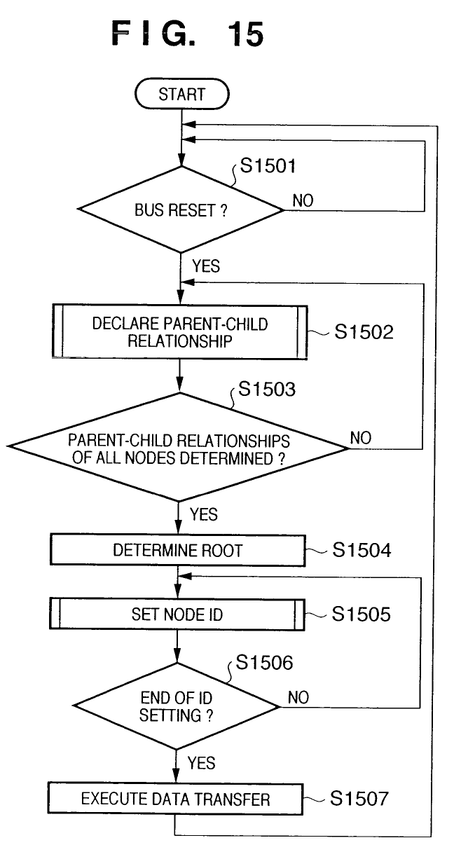

The sequence from the beginning of the bus reset until assignment of node IDs in FIG. 14 will be described below using the flow chart in FIG. 15.

Referring to FIG. 15, nodes A to F, which form the 1394 network, always monitor if a bus reset has occurred (step S1501). When a node that detected a change in connection configuration outputs a bus reset signal, each node executes the following processes.

After the bus reset has occurred, the respective nodes declare parent-child relationships among their communication ports (step S1502).

Each node repeats the process in step S1502 until the parent-child relationships are determined among all the nodes (step S1503).

After the parent-child relationships are determined among all the nodes, the 1394 network determines a node that arbitrates the network, i.e., a root (step S1504).

After the root is determined, the 1394 interface of each node executes a process for automatically setting the self node ID (step S1505).

Each node executes the process in step S1505 based on a predetermined procedure until the node IDs are set for all the nodes (step S1506).

After the node IDs are finally set for all the nodes, each node executes isochronous or asynchronous transfer (step S1507).

The process in step S1507 is executed, and the 1394 interface of each node monitors occurrence of a bus reset again. If the bus reset has occurred, the processes in step S1501 and subsequent steps are executed again.

With the aforementioned sequence, the 1394 interface of each node can automatically recognize a new connection configuration and assign new node IDs every time a bus reset is launched.

(7) Determination of Parent-Child Relationship

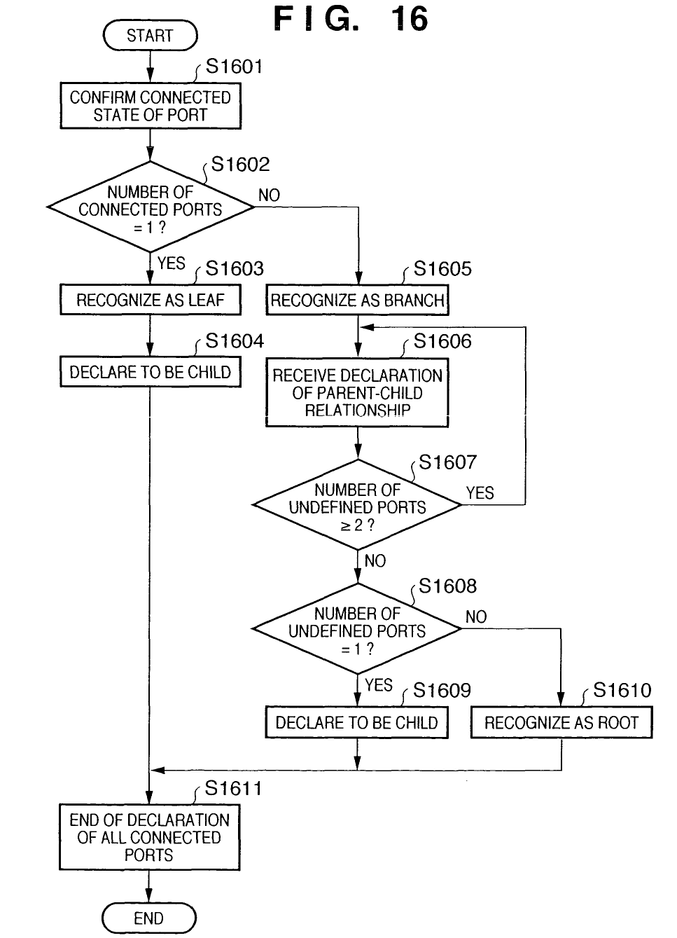

Details of the process in step S1502 in FIG. 15 (i.e., a process for recognizing the parent-child relationships among nodes) will be described below using FIG. 16.

In FIG. 16, after a bus reset has occurred, nodes A to F on the 1394 network confirm the connection states (connected or non-connected) of their communication ports (step S1601).

After the connection states of the communication ports are confirmed, each node counts the number of communication ports connected to other nodes (to be referred to as connected ports hereinafter) (step S1602).

If it is determined as a result of the process in step S1602 that the number of connected ports is one, that node recognizes that the self node is a “leaf” (step S1603). Note that a “leaf” is a node which is connected to only one node.

A “leaf” node declares itself to be a “child” for a node connected to its connected port (step S1604). At this time, the leaf recognizes that its connected port is a “parent port (communication port connected to a parent node)”.

Note that the parent-child relationship is declared first between the leaf as the end of the network and a branch, and is then declared in turn between branches. The parent-child relationships among nodes are determined in turn from a communication port that can declare earlier. The communication port of a node that has declared itself to be a “child” is recognized as a “parent port”, and a communication port that has received that declaration is recognized as a “child port (a communication port connected to a child node)”. For example, in FIG. 14, after each of nodes A, E, and F recognizes that the self node is a leaf, they declare a parent-child relationship. In this manner, nodes A and B, nodes E and D, and nodes F and D are respectively determined to be a child and parent.

On the other hand, if it is determined as a result of the process in step S1602 that the number of connected ports is two or more, that node recognizes that the self node is a “branch” (step S1605). Note that the “branch” is a node which is connected to two or more nodes.

A “branch” node receives declarations of parent-child relationships from nodes connected to its connected ports (step S1606). The connected port that received the declaration is recognized as a “child port”.

After one connected port is recognized as a “child port”, the branch detects if there are two or more connected ports for which a parent-child relationship is not determined yet (i.e., undefined ports) (step S1607). As a result, if there are two or more undefined ports, the branch repeats the process in step S1606.

If it is determined as a result of step S1607 that there is only one undefined port, the branch recognizes that the undefined port is a “parent port”, and declares itself to be a “child” for a node connected to that port (steps S1608 and S1609).

Note that a branch cannot declare itself to be a child for another node until the number of remaining undefined ports becomes 1. For example, in FIG. 14, each of nodes B, C, and D recognizes that the self node is a branch, and receives declaration from a leaf or another branch. Node D declares a parent-child relationship for node C after parent-child relationships are determined between D and E and between D and F. Node C that received the declaration from node D declares a parent-child relationship for node B.

On the other hand, if no undefined port remains as a result of the process in step S1608 (i.e., if all connected ports of the branch become parent ports), that branch recognizes that the self node is a root (step S1610).

For example, in FIG. 14, node B, all the connected ports of which have become parent ports, is recognized by other nodes to be a root for arbitrating communications on the 1394 network. In this case, node B is determined as a root. However, when the declaring timing of a parent-child relationship by node B is earlier than that of node C, another node may become a root. That is, every node may become a root depending on the declaring timing. Hence, a given node does not always become a root even in a fixed network configuration.

In this way, after the parent-child relationships are declared among all connected ports, each node can recognize the connection configuration of the 1394 network as a hierarchical structure (tree structure) (step S1611). Note that the aforementioned parent node is a high-level node in the hierarchical structure, and the child node is a low-level node.

(8) Assignment of Node ID

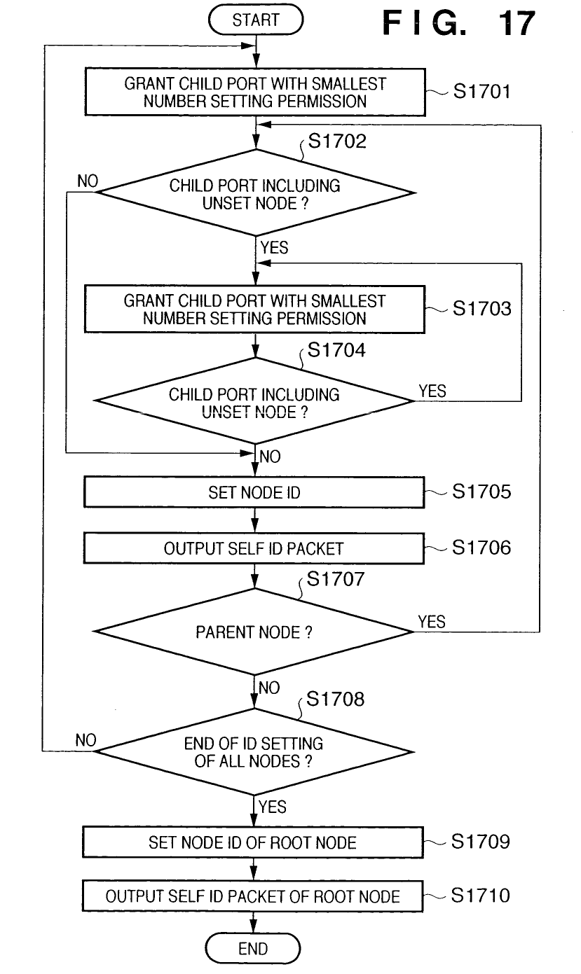

FIG. 17 is a flow chart showing details of the process in step S1505 in FIG. 15 (i.e., a process for automatically assigning node IDs of the respective nodes). Note that the node ID is defined by a bus number and node number. In this embodiment, assume that the respective nodes are connected to a single bus, and an identical bus number is assigned to those nodes.

Referring to FIG. 17, the root grants a communication port having a smallest number of child ports, to which nodes, the node IDs of which are not set yet, are connected, a node ID setting permission (step S1701).

In FIG. 17, the root sets the node IDs of all nodes connected to a child port with the smallest number, then determines that child port to be an already set port, and executes similar control for a child port with the next smallest number. After the node IDs of all the nodes connected to the child ports are set, the root sets the self node ID. The node number contained in the node ID is basically assigned like 0, 1, 2, . . . in the order of leaves and branches. Hence, the root has the largest node number.

The node granted the setting permission in step S1701 determines whether or not its child ports include nodes for which node IDs are not set yet (step S1702).

If a child port including a node for which a node ID is not set yet is detected in step S1702, the node granted the aforementioned setting permission controls to grant a node directly connected to that child port the setting permission (step S1703).

After the process in step S1703, the node granted the setting permission determines whether or not its child ports include nodes for which node IDs are not set yet (step S1704). If a child port including a node for which a node ID is not set yet is detected after the process in step S1704, that node repeats the process in step S1703.

On the other hand, if no child port including a node for which a node ID is not set yet is detected in step S1702 or S1704, the node granted the setting permission sets the self node ID (step S1705).

The node that has set the self node ID broadcasts a self ID packet containing information which pertains to the self node number, the connection states of communication ports, and the like (step S1706). Note that broadcasting is to transfer a communication packet of a given node to unspecified many nodes that form the 1394 network.

Upon receiving the self ID packet, each node can recognize the node numbers assigned to the respective nodes, and can detect a node number assigned to itself. For example, in FIG. 14, node B as the root grants node A connected to a communication port with a smallest port number “#1” a node ID setting permission. Node A assigns the self node number “No. 0”, and sets a node ID containing the bus number and node number for itself. Also, node A broadcasts a self ID packet containing that node number.

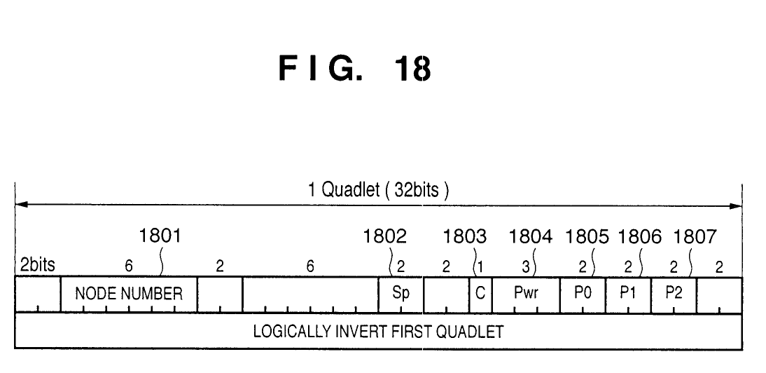

FIG. 18 shows an example of the format of the self ID packet. Referring to FIG. 18, reference numeral 1801 denotes a field for storing the node number of a node that output the self ID packet; 1802, a field for storing information which pertains to a compatible transfer rate; 1803, a field indicating the presence/absence of a bus management function (the presence/absence of ability of a bus manager or the like); and 1804, a field for storing information that pertains to characteristics of consumption and supply of electric power.

Also, in FIG. 18, reference numeral 1805 denotes a field for storing information that pertains to the connection state of a communication port with a port number “#0” (connected, non-connected, the parent-child relationship of the communication port, and the like); 1806, a field for storing information that pertains to the connection state of a communication port with a port number “#1” (connected, non-connected, the parent-child relationship of the communication port, and the like); and 1807, a field for storing information that pertains to the connection state of a communication port with a port number “#2” (connected, non-connected, the parent-child relationship of the communication port, and the like).

When a node that outputs the self ID packet has an ability to be a bus manager, a contender bit in the field 1803 is set at “1”; otherwise, the contender bit is set at “0”.

Note that the bus manager is a node which has functions of performing power supply management of the bus (that manages information indicating whether or not electric power can be supplied via a communication cable, whether or not power supply is required, and so forth for respective nodes), management of rate information (that manages the maximum transfer rate among nodes on the basis of information which pertains to compatible transfer rates of the respective nodes), management of topology map information (that manages the connection configuration of the network on the basis of the parent-child relationship information of communication ports), optimization of the bus based on the topology map information, and the like, and providing such information to another node. With these functions, the node that serves as a bus manager can perform bus management of the overall 1394 network.

After the process in step S1706, the node that has set the node ID determines whether or not a parent node is present (step S1707). If a parent node is present, that parent node executes the processes in step S1702 and subsequent steps again. Then, that node grants a node for which the node ID is not set yet a permission.

On the other hand, if no parent node is present, that node determines that it is the root itself. The root determines whether or not node IDs have been set for nodes connected to all child ports (step S1708).

If the ID setting process for all the nodes is not complete in step S1708, the root grants one with a smallest number of child ports including that node an ID setting permission (step S1701). After that, the node executes the processes in step S1702 and subsequent steps.

On the other hand, if the ID setting process for all the nodes is complete, the root sets the self node ID (step S1709). After the node ID is set, the root broadcasts a self ID packet (step S1710).

With the aforementioned process, the 1394 network can automatically assign node IDs to the respective nodes.

After the node ID setting process, if a plurality of nodes have an ability of bus manager, a node with the largest node number becomes a bus manager. That is, if the root having the largest node number in the network has a function of a bus manager, the root becomes a bus manager.

However, if the root does not have such function, a node having the next largest node number to the root becomes a bus manager. Which of nodes becomes a bus manager can be detected by checking the contender bit 1803 in a self ID packet broadcasted by each node.

(9) Arbitration

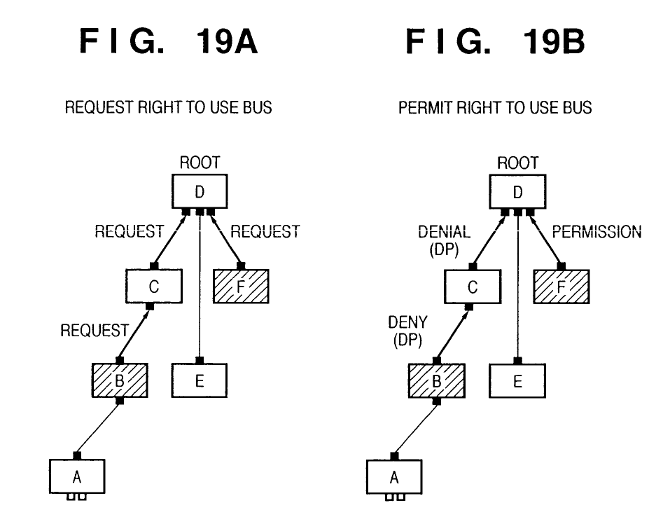

FIGS. 19A and 19B are diagrams for explaining arbitration in the 1394 network in FIG. 2.

In the 1394 network, arbitration of the right to use a bus is made prior to data transfer. The 1394 network is a logical bus network, and an identical packet can be transferred to all the nodes in the network by relaying a communication packet transferred from each node to another node. Hence, arbitration is required to prevent communication packets from colliding. As a result, only one node can transfer at a given timing.

FIG. 19A is a diagram for explaining a case wherein nodes B and F issue requests for the right to use a bus.

After the arbitration begins, nodes B and F issue requests for the right to use a bus to their parent nodes. Upon receiving the request from node B, a parent node (i.e., node C) relays that request for the right to use a bus to its parent node (i.e., node D). This request is finally delivered to the root (node D) that actually arbitrates.

Upon receiving the bus use request, the root determines a node which can use the bus. The arbitration can be done by only the node that serves as a root, and a node that wins arbitration is granted the right to use the bus.

FIG. 19B shows a state wherein the request from node F is granted, and that from node B is denied.

The root sends a DP (Data prefix) packet to the node that loses arbitration, and informs it of denial. The denied node postpones the bus use request until the next arbitration.

By controlling arbitration in this way, the 1394 network can manage the right to use the bus.

(10) Communication Cycle

The isochronous and asynchronous transfer modes can time-divisionally mix within each communication cycle period. Note that the communication cycle period is normally 125 is.

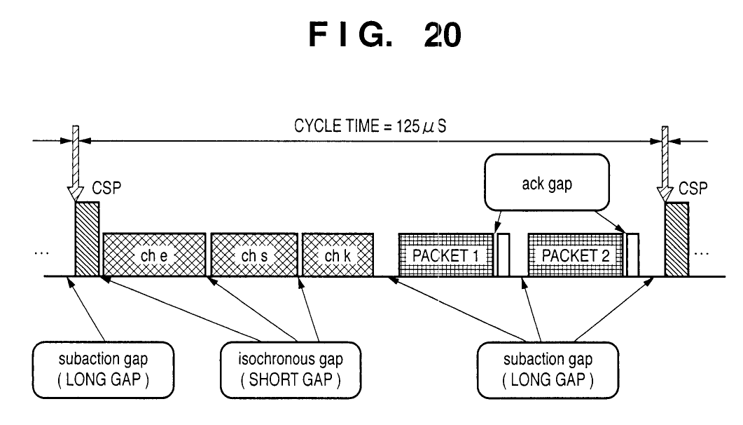

FIG. 20 is a view for explaining a case wherein the isochronous and asynchronous transfer modes mix within one communication cycle.

The isochronous transfer mode is executed in preference to the asynchronous transfer mode. This is because an idle period (subaction gap) required to launch asynchronous transfer after a cycle start packet is set to be longer than an idle period (isochronous gap) required to launch isochronous transfer. For this reason, isochronous transfer is executed in preference to asynchronous transfer.

In FIG. 20, upon starting each communication cycle, a cycle start packet (to be abbreviated as CSP hereinafter) is transferred from a predetermined node. Each node adjusts time using this CSP to measure time using the same reference as other nodes.

(11) Isochronous Transfer Mode

The isochronous transfer mode is an isochronous transfer scheme. Isochronous mode transfer can be executed during a predetermined period after the communication cycle starts. Also, the isochronous transfer mode is always executed in each cycle to maintain real-time transfer.

The isochronous transfer mode is especially suitable for transfer of data such as moving image data, audio data, and the like which require real-time transfer. The isochronous transfer mode is not a one-to-one communication unlike the asynchronous transfer mode, but is a broadcast communication. That is, a packet output from a given node is evenly transferred to all nodes on the network. Note that isochronous transfer does not use any ack (reception confirmation reply code).

In FIG. 20, channel e (ch e), channel s (ch s), and channel k (ch k) indicate periods in which respective nodes make isochronous transfer. In the 1394 interface, different channel numbers are given to identify a plurality of different isochronous transfers. In this way, isochronous transfer can be done among a plurality of nodes. Note that the channel number does not specify a destination but merely assigns a logical number to data.

The isochronous gap shown in FIG. 20 indicates an idle state of the bus. After an elapse of a predetermined period of time in this idle state, a node that requires isochronous transfer determines that the bus can be used, and executes arbitration.

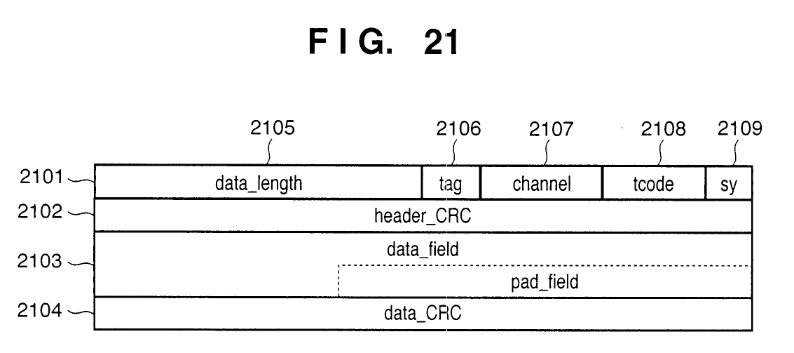

FIG. 21 shows the format of a communication packet transferred based on the isochronous transfer mode. A communication packet transferred based on the isochronous transfer mode will be referred to as an isochronous packet hereinafter.

In FIG. 21, an isochronous packet is made up of a header area 2101, header CRC 2102, data area 2103, and data CRC 2104.

The header area 2101 includes a field 2105 for storing the data length of the data area 2103, a field 2106 for storing format information of the isochronous packet, a field 2107 for storing the channel number of the isochronous packet, a field 2108 for storing a transaction code (tcode) that identifies the format of the packet and a process to be executed, and a field 2109 for storing a synchronization code.

(12) Asynchronous Transfer Mode

The asynchronous transfer mode is an asynchronous transfer scheme. Asynchronous transfer can be executed during a period after the completion of the isochronous transfer period until the next communication cycle starts (i.e., a period until the CSP of the next communication cycle is transferred).

In FIG. 20, the first subaction gap indicates an idle state of the bus. After this idle time has reached a given value, a node that requires asynchronous transfer determines that the bus can be used, and executes arbitration.

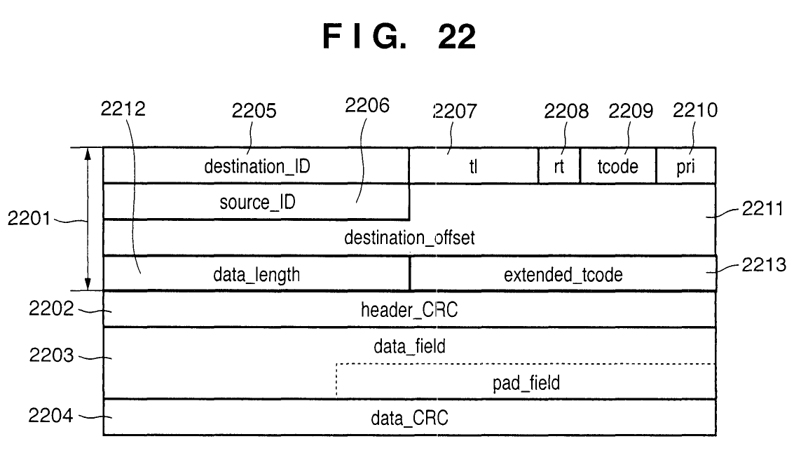

A node that acquires the right to use the bus by arbitration transfers a packet shown in FIG. 22 to a predetermined node. Upon receiving this packet, the node sends back ack (reception confirmation reply code) or a response packet after an ack gap.

FIG. 22 shows the format of a communication packet based on the asynchronous transfer mode. A communication packet transferred based on the asynchronous transfer mode will be referred to as an asynchronous packet hereinafter.

Referring to FIG. 22, an asynchronous packet is made up of a header area 2201, header CRC 2202, data area 2203, and data CRC 2204.

In the header area 2201, a field 2205 stores the node ID of a destination node, a field 2206 stores the node ID of the source node, a field 2207 stores a label indicating a series of transactions, a field 2208 stores a code indicating resend status, a field 2209 stores a transaction code (tcode) that identifies the format of the packet and a process to be executed, a field 2210 stores the priority order, a field 2211 stores the memory address of the destination, a field 2212 stores the data length of the data area, and a field 2213 stores an extended transaction code.

Asynchronous transfer is a one-to-one communication from the self node to the partner node. A packet transferred from a source node in the asynchronous transfer mode is transferred to all nodes in the network, but is ignored if it is not addressed to the self node. Hence, only the node as the destination can read that packet.

When the transfer timing of the next CSP is reached during asynchronous transfer, the transfer is not forcibly interrupted, and the next CSP is sent after the completion of that transfer. When one communication cycle exceeds 125 μs, the next communication cycle is shortened accordingly. In this manner, the 1394 network can maintain nearly constant communication cycles.

(13) Device Map

As means that allows an application to detect the topology of the 1394 network to generate a device map, the following means are available on the IEEE1394 standard.

1. A topology map register of a bus manager is read.

2. The topology is estimated from the self ID packet upon bus reset.

However, these means 1 and 2 can detect the topology in the order of cable connection based on the parent-child relationships of respective nodes, but cannot detect the topology of physical positional relationship (even non-implemented ports are seen as another problem).

As another means, information required to generate a device map may be provided as a database in addition to the configuration ROM. In such case, means for acquiring various kinds of information depends on the protocol used to access the database.

The configuration ROM itself and the function of reading the configuration ROM are inevitably provided to a device complying with the IEEE1394 standard. Hence, by storing information such as a device position, functions, and the like in the configuration ROM of each device, and providing a function of reading such information to an application, the application of each node can implement a so-called device map display function independently of a specific protocol such as database access, data transfer, or the like.

That is, the configuration ROM can store a physical position, functions, and the like as information unique to each node, and such information can be used to implement the device map display function.

In this case, a method that allows an application to detect the 1394 network topology based on the physical positional relationship by reading the configuration ROMs of respective nodes upon execution of a bus reset or receiving a user's request is available. Furthermore, when the configuration ROM describes not only the node physical position but also various kinds of node information such as functions and the like, the function information and the like of each node can be acquired simultaneously with the node physical position by reading the configuration ROM. Upon acquiring configuration ROM information of each node by an application, an API that acquires arbitrary configuration ROM information of a designated node is used.

With such means, an application of a device on the IEEE1394 network can generate various device maps such as a physical topology map, function maps of nodes, and the like in correspondence with the intended purposes. Also, the application can select a device having a function that the user requires.

(14) Overview of SBP-2

SBP-2 (Serial Bus Protocol2) is a protocol that pertains to an IEEE1394 bus, the standardization of which was taken into deliberations since 1996 as a project of Technical Committee T10 affiliated with NCITS, and was licensed in 1998 as ANSI NCITS 325-1998. As a layer, SBP-2 is a command/data transfer protocol, which is located above the transaction layer of IEEE1394-1995. Originally, SBP-2 was developed to operate devices on IEEE1394 using SCSI commands as its principal object. However, not only SCSI commands but also other commands can be used.

SBP-2 has the following four features.

1) SBP-2 is a master slave model with the initiator/target configuration, and an initiator as a master has all authorities and responsibilities over login, logout, task management, command issuance, and the like.

2) SBP-2 is a shared memory model that utilizes the features of IEEE1394 as a bus model. All request contents to a target such as commands and the like are basically stored in a system memory, and the target that received a request reads the contents of the system memory. Or the target writes information such as requested status or the like in the system memory.

That is, since communication resources can be concentrated in one space, the loads on resources can be reduced very much. In addition, since the target can read/write the system memory at its own pace, the degree of freedom in design of the target is high, and high-speed access to the system memory can be achieved by H/W implementation. That is, both a high-performance model and thorough low-cost model can be obtained.

3) Since there is a mechanism for describing a command group for message exchange as a series of link lists, it can cover up an efficiency drop due to latency, and high-speed, efficient data communications that can utilize the features of the IEEE1394 bus can be realized.

4) The SBP-2 structure is independent from any command set. In other words, SBP-2 is compatible to various command sets.

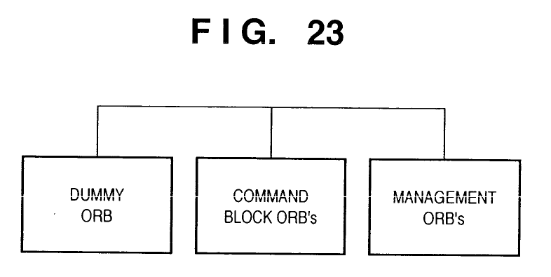

As described in feature 1), since SBP-2 is the master slave model in which the initiator as a master has all authorities and responsibilities, a login or logout request, task management request, command, and the like are sent to the target while being included in a data structure called an ORB (Operation Request Block). Strictly speaking, the initiator sets such requests and commands in the self memory, and the target reads out them. FIG. 23 shows the types of principal ORBs.

1) Dummy ORB: This ORB is used upon initializing a target fetch agent, upon canceling a task, and so forth. The target handles this ORB as no operation.

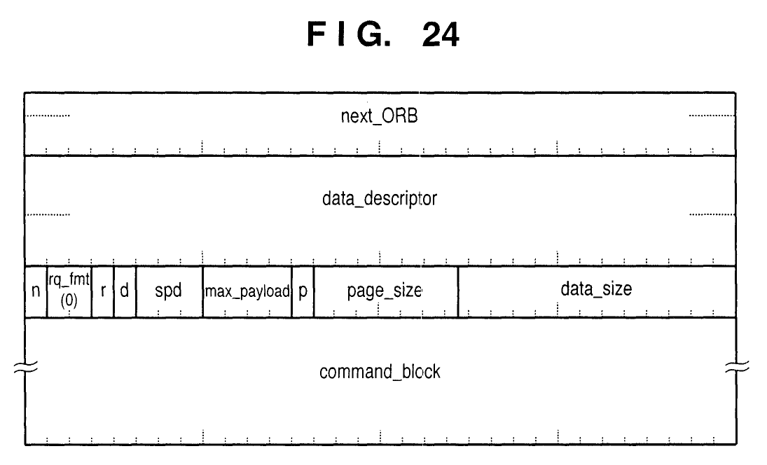

2) Command Block ORB: This ORB contains commands such as a data transfer command, device control command, and the like. FIG. 24 shows details of the command block ORB. The command block ORB has a data descriptor (data_descriptor) and data size field (data_size) which indicate the address and size of a corresponding data buffer or page table. Since the command block ORB has a next ORB field (next_ORB) which indicates the address of the next command block ORB, it is characterized by linking commands.

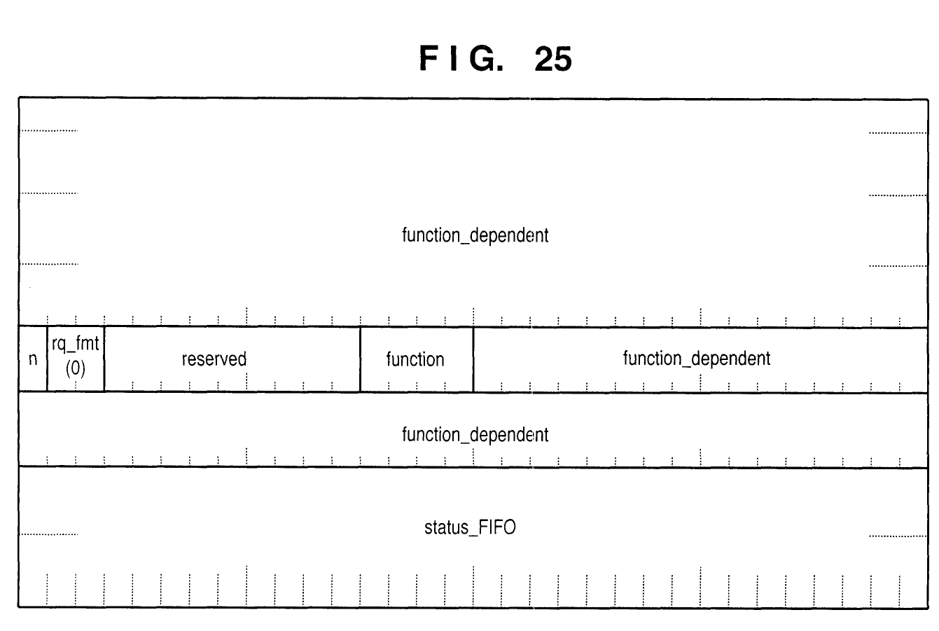

3) Management ORB: This ORB contains management requests (access requests including login and logout requests, and task management requests). FIG. 25 shows details of the management ORB. The management ORB is characterized by having a function field (function) indicating the request contents (abort task set, target reset, and the like) of task management, and a status FIFO (Status_FIFO) field indicating the address of completion status from the target.

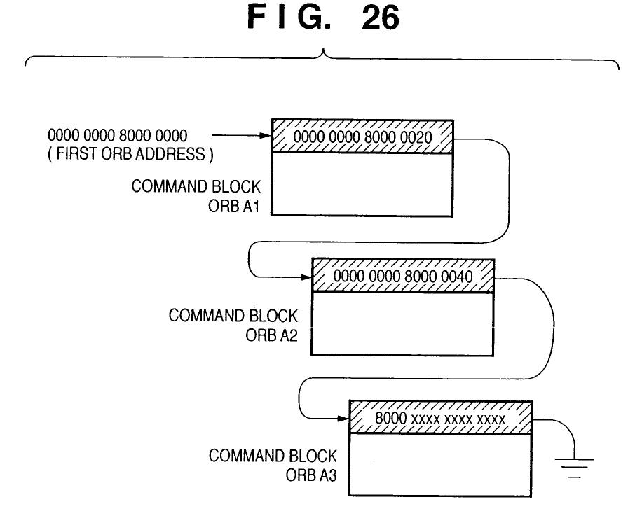

Of these ORBs, as for the management ORB, the initiator cannot issue the next ORB until the target returns a response. On the other hand, since the command block ORB including the dummy ORB has a field that designates the address of the next ORB as the next ORB field, as shown in FIG. 24, commands can be linked in turn, and a series of commands can be issued in the form of a link list, as shown in FIG. 26. If this next ORB field is null, it indicates that no next ORB follows.

Other fields of this command block ORB include fields (data descriptor and data size) indicating the address and size of a data buffer or page table. For example, if the command contents indicate a write command, the target accesses a data buffer on the system memory designated by the data descriptor, and reads write data from that buffer. On the other hand, if the command contents indicate a read command, the target accesses a data buffer on the system memory designated by the data descriptor, and writes data requested by the command in that buffer.

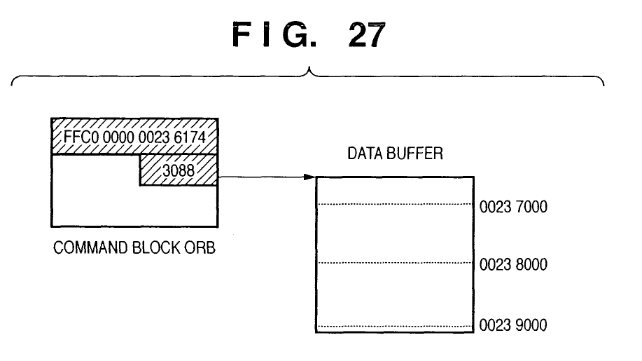

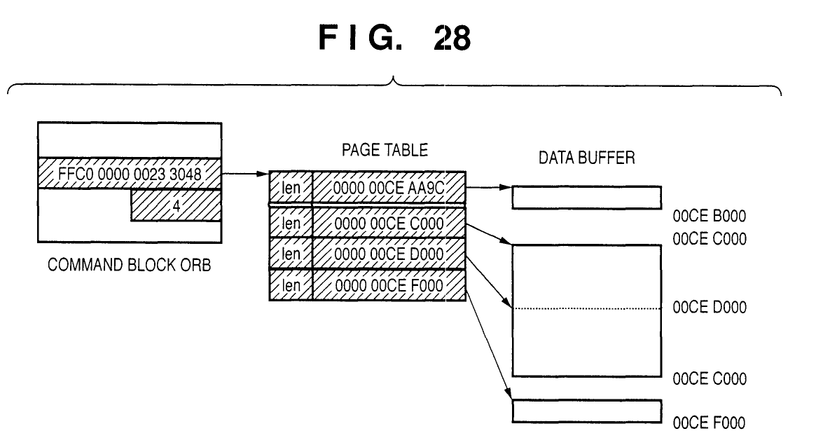

FIGS. 27 and 28 show a case wherein the command block ORB directly designates a data buffer, and a case wherein it designates data buffers via a page table. The page table allows to continuously handle data buffers on physically discontinuous areas, and the need for physically relocating continuous logical areas assigned by virtual storage can be obviated.

A mechanism on the target side, which executes various requests from the initiator, is called an agent. The agent includes a management agent which executes management ORBs, and a command block agent which executes command block ORBs.

The management agent includes a management agent register in which the initiator stores the address of a management ORB so as to inform the target of that address.

The command block agent is also called a fetch agent, since it fetches a command from the command link list of the initiator. The fetch agent has a command block agent register which includes an ORB pointer register in which the initiator stores the start address of a command block ORB, a doorbell register with which the initiator informs the target of the presence of a command to be fetched, and the like.

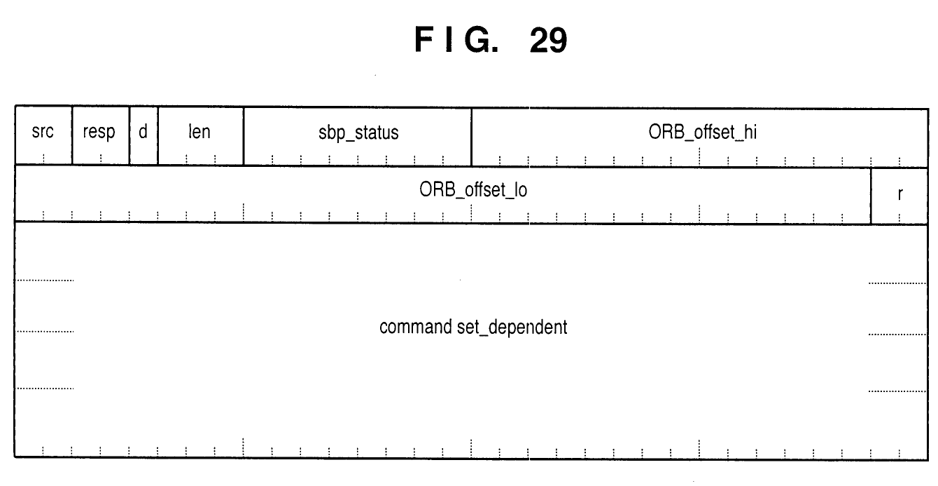

Upon completion of execution of an ORB from the initiator, the target stores execution completion status at an address designated by the status FIFO of the initiator in the form of a data structure called a status block (irrespective of the result of completion). FIG. 29 shows an example of the status block.

The target can store status information ranging from 8 bytes (minimum) to 32 bytes (maximum). In case of a management ORB, since the status FIFO address is explicitly provided as a part of the ORB in the status FIFO field in FIG. 25, the target stores the status block at the designated address. In other cases, the target stores the status block at the status FIFO address obtained from the context of the fetch agent. In case of a command block ORB, the initiator provides the status FIFO address as a part of a login request.

Normally, the target responds to an ORB issued by the initiator by rewriting a status block at the status FIFO address. However, when a change has occurred on the device side and influences a logical unit, the target can voluntarily return unsolicited status without any request from the initiator. The status FIFO address in this case is the one that is provided from the initiator upon reception of a login request from the initiator.

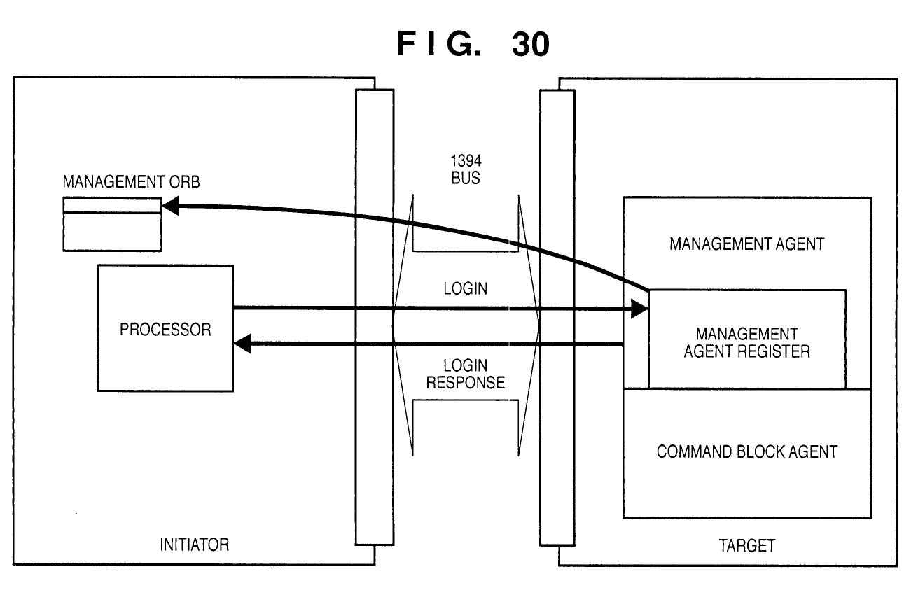

The operations of the initiator and target in SBP-2 will be explained below using an operation model shown in FIG. 30.

The operation of SBP-2 starts from a management ORB (login ORB) which is issued by the initiator to issue a login request to the target. The target returns a login response in response to the request from the initiator.

After the login request is accepted, the target returns the start address of the command block agent register as a login response.

Also, the management agent of the target accepts the subsequent task management request from the initiator. The initiator issues a task management ORB to exchange information required to execute a task with the target. The target responds to the ORB issued by the initiator by rewriting a status block at the status FIFO address. However, when a change has occurred on the device side and influences a logical unit, the target can voluntarily return unsolicited status without any request from the initiator, as described above.

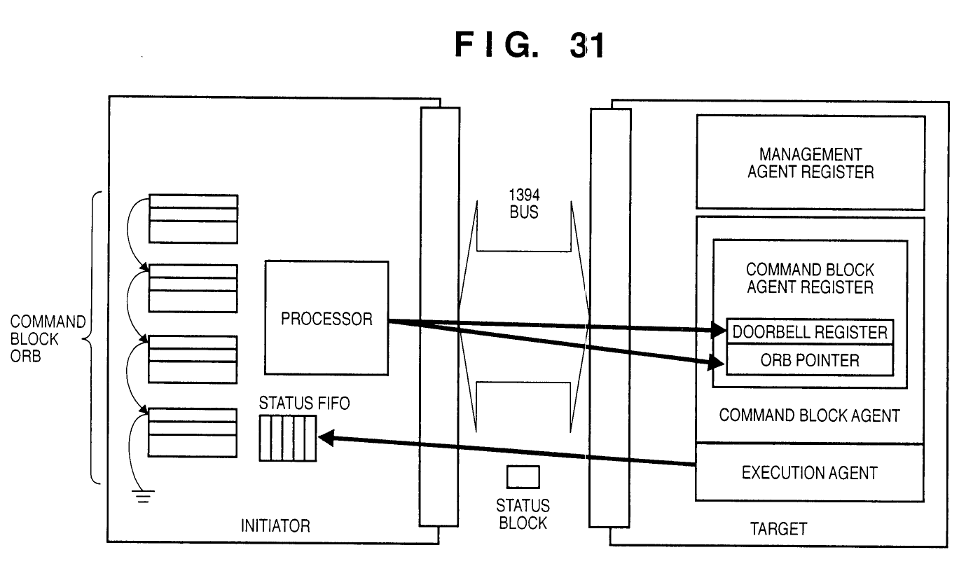

After exchange of information associated with task management, the initiator forms a required command block ORB (list) on its own memory area. As shown in FIG. 31, the initiator informs the target that it stores ORBs to be fetched by writing the start address of the ORB in the ORB pointer of the command block agent register of the target or by ringing the doorbell register of the command block agent register.

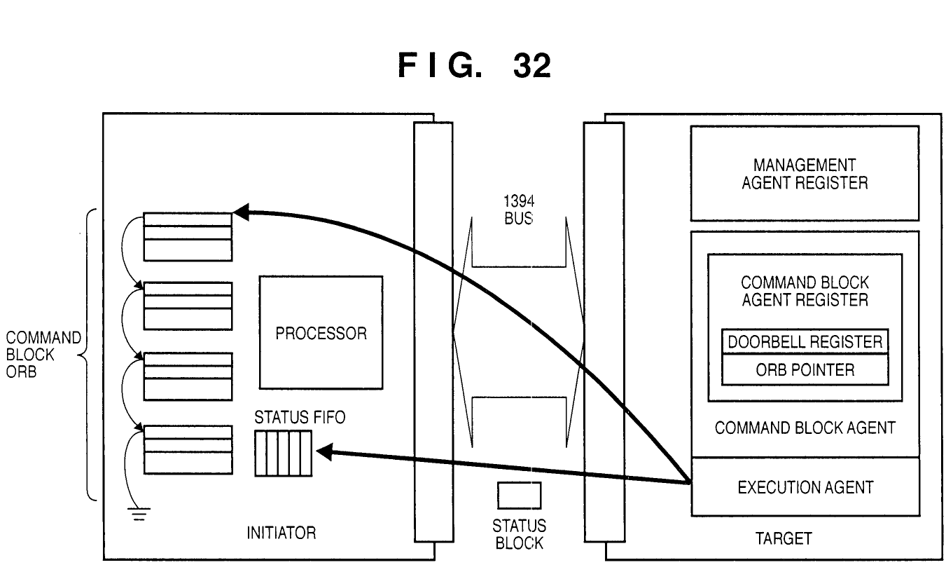

In response to this, the target accesses the memory of the initiator based on the start address information of the ORBs written in the ORB pointer, and sequentially processes the ORBs, as shown in FIG. 32.

Meanwhile, a task execution model includes an ordered model and unordered model. In the ordered model, the ORBs are processed in the order of the list, and the target returns completion status in turn. In the unordered model, the execution order of ORBs is not limited, but the initiator must have a responsibility to finally obtain the same execution results irrespective of the order of execution.

Data transfer from the initiator to the target is made by a read transaction from the target to the system memory, while data transfer from the target to the initiator is made by a write transaction to the system memory. That is, the target leads data buffer transfer irrespective of directions. In other words, the target can read out data from the system memory at its own pace. The initiator can add an ORB to the link list by rewriting the next address of the last ORB in the list to the address of the next ORB, and informing the target of that change by ringing the doorbell register of the target again, even when the target is executing the ORBs. The target returns completion status (status block) to the status FIFO address. The initiator can detect completion of execution of an ORB of interest by the target based on the completion status (status block) returned from the target. The completed ORB can be removed from the link list of a task set (as long as its next ORB field is not null). The initiator may add the next command to the end of the command link list if required using that free resource.

In this manner, ORBs are executed, and a task is executed.

After completion of a task, if the initiator need not continue to access, it issues a logout ORB, and the target responds to that ORB, thus completing logout.

(15) Overview of SBP-3

SBP-3 has been standardized since the late of 2000 for the purpose of correcting inefficient points and missing functions of SBP-2 by expanding SBP-2 and adding functions.

Representative functions expanded in SBP-3 are as follows.

1. Isochronous data transfer function

2. Node ID independent function that specifies initiator/target by device handle

3. Two-way data transfer function in one ORB

Of these functions, function 3 will be explained below.

SBP-3 has downward compatibility to SBP-2, and its basic data transfer sequence is as has been explained in the overview of SBP-2. That is, data transfer from the initiator to the target is made by a read transaction from the target to the system memory, while data transfer from the target to the initiator is made by a write transaction to the system memory. The target reads out an ORB at its own pace, and detects type information of a transfer operation by decoding the contents of the ORB. The target decodes to determine whether the transfer operation corresponding to the ORB is data transfer from the initiator to the target or data transfer from the target to the initiator, and a destination system memory area of that transfer operation, and executes the corresponding transfer operation. Upon completion of the transfer operation designated by that ORB, the target returns completion status (status block) to the status FIFO address of the initiator.

SBP-3 defines two different types of command block ORBs, i.e., ORBs which contain commands such as a data transfer command, device control command, and the like. One type is a command block ORB in which a request format field has a value “0”, and is the same as that defined in SBP-2. As has been explained in “(14) Overview of SBP-2”, this command block ORB has a data descriptor and data size fields which indicates the address and size of a data buffer or page table to be referred to by the ORB, a next ORB field indicating the address of the next command block ORB, and fields used to designate parameters associated with data transfer (e.g., a direction field indicating the data transfer direction with respect to the data buffer).

In a new command block ORB defined by SBP-3, a request format field has a value “I” to distinguish this command block ORB from a conventional ORB.

This ORB is characterized in that one ORB refers to two data buffers.

Two sets of data descriptor and data size fields which indicate the address and size of a data buffer or page table, and fields associated with data buffers (e.g., direction fields) are prepared, and the ORB can refer to two data buffers.

This ORB can be used as a two-way ORB, so that one data buffer is used as a write buffer to the target, and the other data buffer is used as a read buffer from the target.

The initiator forms a required command block ORB list on its own memory area, and appends the aforementioned two-way ORB to the list. The initiator then informs the target that it stores ORBs to be fetched by writing the start address of the ORB list in the ORB pointer of the command block agent register of the target or by ringing the doorbell register of the command block agent register. The target accesses the memory of the initiator on the basis of the start address information of the ORB written in the ORB pointer to fetch ORBs, and sequentially processes them.

The target which fetched the two-way ORB executes data transfer processes for the two designated data buffers. A direction field corresponding to one buffer assumes 0, and the target accesses a data buffer on the system memory designated by the data descriptor to read write data from that buffer. A direction field corresponding to the other buffer assumes 1, and the target accesses a data buffer on the system memory designated by the data descriptor to write data requested by the command.

Upon completion of these two data buffer accesses, the target returns completion status (status block) to the status FIFO address of the initiator so as to notify completion of execution of that ORB.

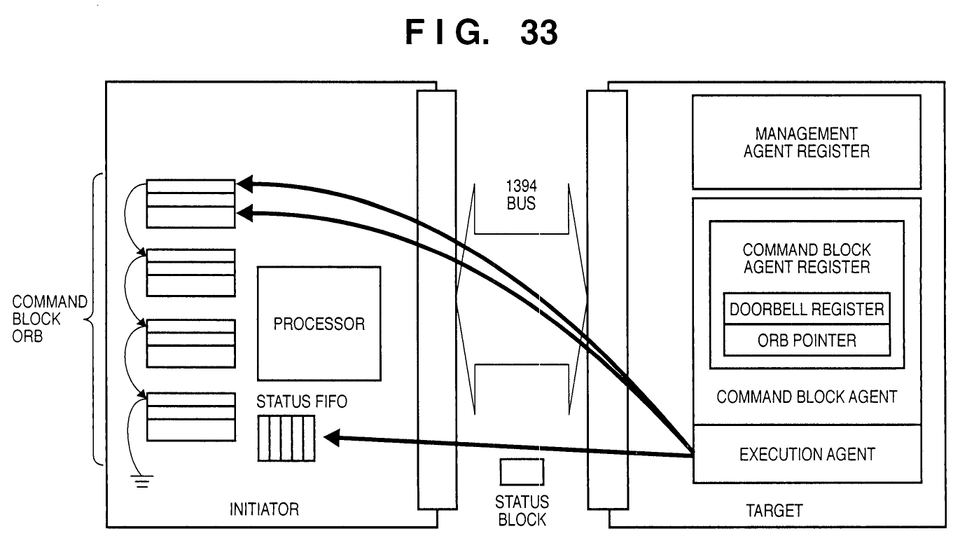

FIG. 33 shows the operation of the command block ORB in SBP-3. As compared to SBP-2 shown in FIG. 32, two data buffer access lines are drawn to one ORB in SBP-3, and a drawback of SBP-2 that can access only one data buffer has been improved. Since two data buffers can be independently accessed, two data channels from the initiator to the target can be applied to one ORB. Each data buffer can specify a data flow direction to or from it. That is, two data channels can be used to transmit data from the initiator to the target, or one channel can be used to transmit data from the initiator to the target and the other channel can be used to transmit data from the target to the initiator. Of course, two data channels can be used to transmit data from the target to the initiator. Furthermore, when a host and printer use such protocol, one channel can be used to send print data from the host to the printer, and the other channel can be used to pass status information from the printer to the host.

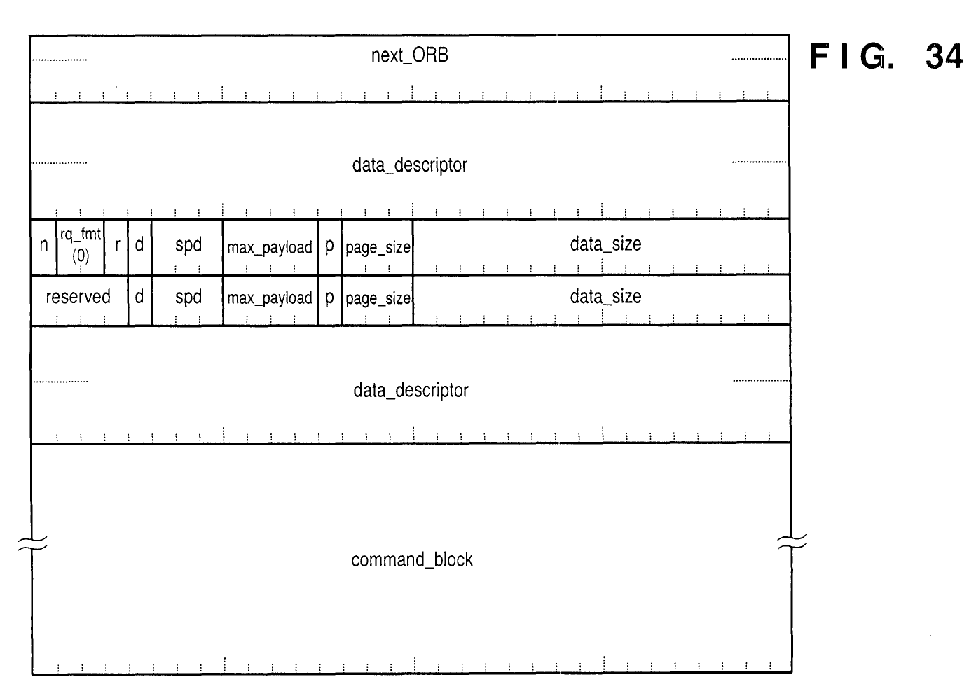

FIG. 34 shows details of the command block ORB upon holding two data buffers in SBP-3. Unlike in SBP-2, two data descriptors and two buffer information fields are prepared to handle a pair of data buffers. In FIG. 34, fields indicated by “d” can be used to designate the directions of corresponding data buffers. The contents of these fields are the same as those in SBP-2: if “d”=0, it indicates a direction from the initiator to the target; if “d”=1, it indicates a direction from the target to the initiator.

<Arrangement of Each Node>

The arrangement of a 1394 serial bus interface block of each node connected to the IEEE1394 bus will be explained first.

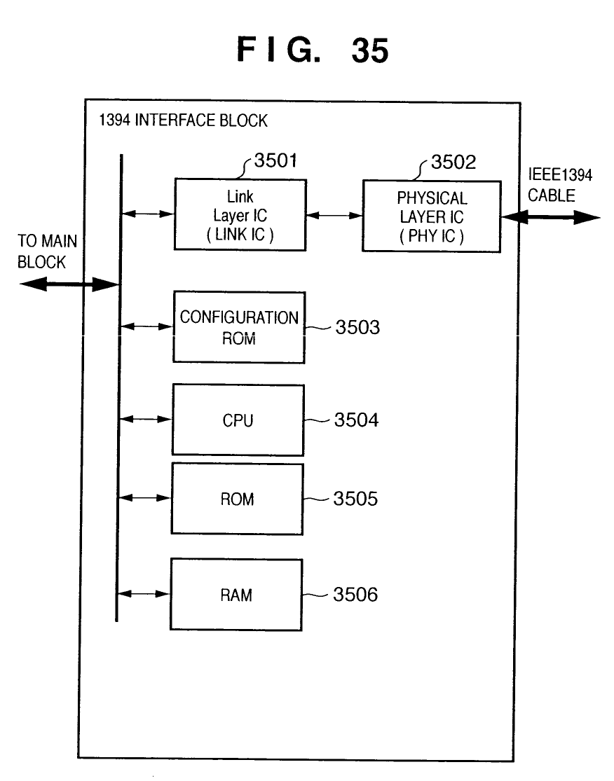

FIG. 35 is a block diagram showing the basic arrangement of the 1394 interface block.

Referring to FIG. 35, reference numeral 3502 denotes a physical layer control IC (PHY IC) which directly drives the 1394 serial bus, and implements the function of the physical layer in <Technical Overview of IEEE1394> above. Principal functions of this IC include bus initialization and arbitration, encoding/decoding of transmission data codes, monitoring of a cable energization state and supply of a load termination power supply (to confirm active connection), and interfacing with the link layer IC.

Reference numeral 3501 denotes a link layer control IC (LINK IC) which interfaces with a device main body, and controls data transfer of the PHY IC. The LINK IC implements the function of the link layer in <Technical Overview of IEEE1394> above. Principal functions of this IC include a transmission/reception FIFO for temporarily storing transmission/reception data via the PHY IC, a packetization function of transmission data, a discrimination function of checking if data received by the PHY IC is addressed to this node address or assigned channel in case of isochronous transfer data, a receiver function of checking errors of that data, and a function of interfacing with a device main body.

In FIG. 35, reference numeral 3504 denotes a CPU which controls the 1394 interface block including the link layer IC, PHY IC, and the like; and 3505, a ROM that stores a control program of the interface block.

Reference numeral 3506 denotes a RAM which is used as a data buffer for storing transmission/reception data, a control work area, and data areas of various registers mapped at 1394 addresses.

In FIG. 35, reference numeral 3503 denotes a configuration ROM which stores identification information unique to each device, communication conditions, and the like. The data format of this ROM complies with that specified by the IEEE1212 and IEEE1394 standards, as has been explained in <Technical Overview of IEEE1394>.

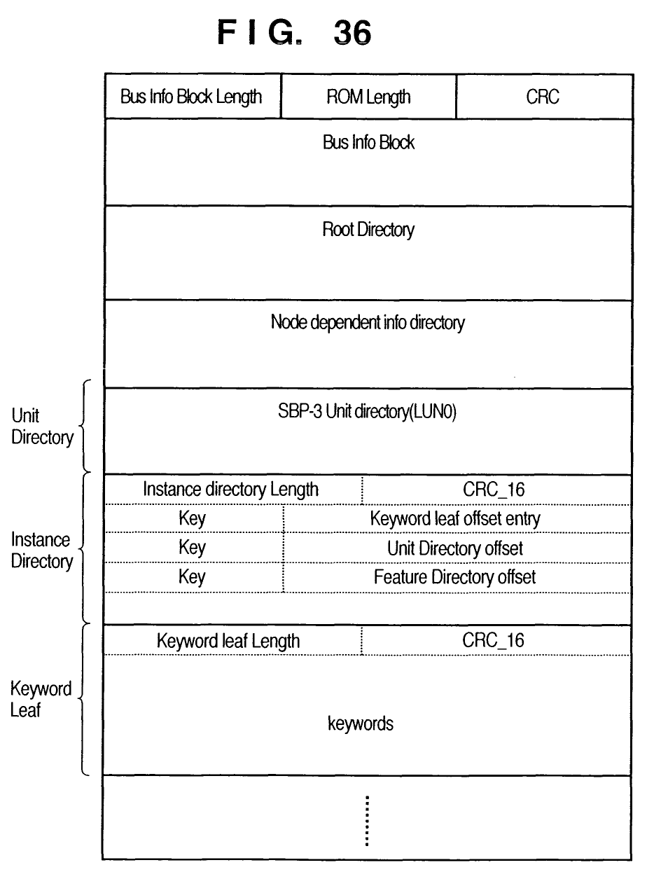

Each node comprises the configuration ROM of the general format shown in FIG. 36, in which software unit information of each device is saved in a unit directory, and information unique to the node is saved in a node dependent info directory.

In case of a printer of this embodiment, an ID that identifies SBP-3 is stored in the unit directory so as to support SBP-3 as a communication protocol.

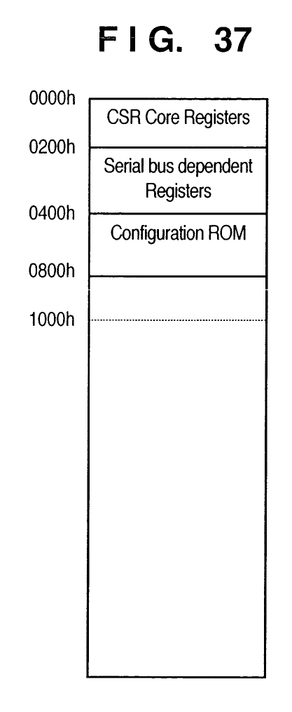

As has been explained in <Technical Overview of IEEE1394>, the last 28 bits of address setups of the 1394 serial bus are assured as an area of data unique to each device, which can be accessed by another device connected to the serial bus. FIG. 37 shows this 28-bit address space.

In FIG. 37, CSR core registers are allocated in an area from addresses 0000 to 0200.

These registers are present as a basic function for node management specified in the CSR architecture.

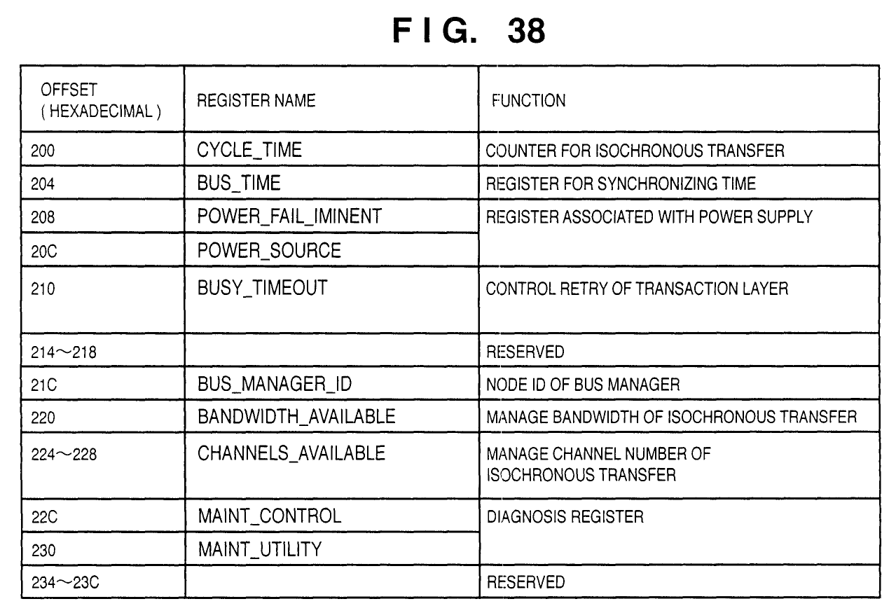

An area from addresses 0200 to 0400 is defined as an area that stores registers associated with the serial bus by the CSR architecture. FIG. 38 shows the configuration of this area in detail. In FIG. 38, registers of addresses 0200 to 0230 are defined as those associated with the serial bus, and those used in data transfer synchronization, power supply, bus resource management, and the like are allocated. Note that the configuration ROM is allocated in an area from addresses 400 to 800.

An area from addresses 0800 to 1000 stores the current topology information of the 1394 bus, and information that pertains to the transfer rate between nodes.

An area after address 1000 is called a unit space, in which registers associated with operations unique to each device are allocated. In this area, registers and a data transfer mapped buffer area specified by a high-level protocol that each device supports, and registers unique to each device are allocated.

<Information Processing System According to This Embodiment>

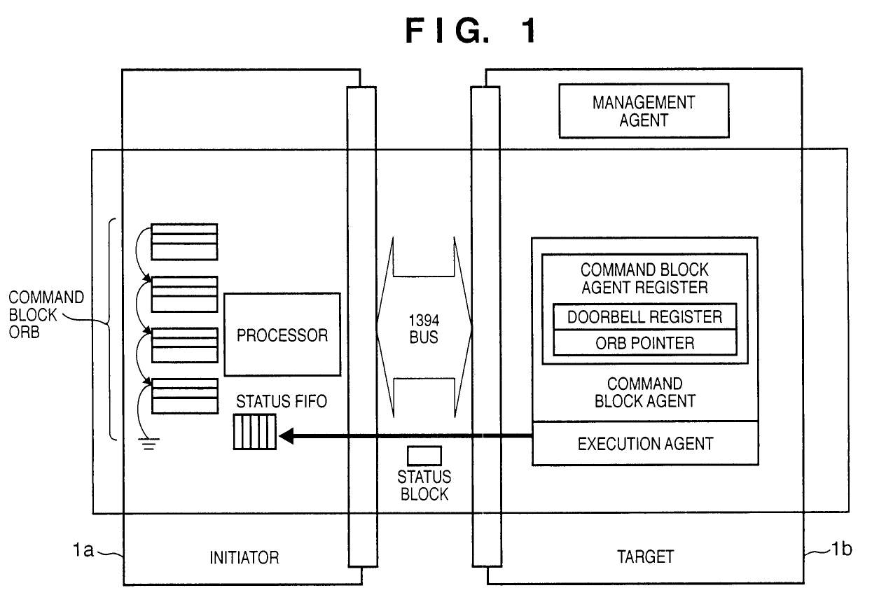

FIG. 1 shows an information processing system of this embodiment, and represents a host computer (to be referred to as a host hereinafter) 1a and printer 1b, which are connected via IEEE1394.

Communications between the host 1a and printer 1b are made using the SBP (Serial Bus Protocol)-3 protocol as a representative data transfer protocol used on the IEEE1394 interface, and LUN0 is defined in advance as a communication channel used to make data transfer between the host and printer.

In the system shown in FIG. 1, the host 1a serves as the initiator using the SBP-3 protocol and communicates with the printer 1b as the target of SBP-3. In this communication system, host-printer communications are made based on a printer control communication command protocol, which is specified in advance as a high-level command set of the SBP-3 protocol, and processes are executed according to commands.

The printer 1b comprises a plurality of data transfer channels CH1 and CH2, which respectively provide a function of receiving and processing printer control and print data sent from the host 1a, and a function of sending current print status data to the host in response to control to the printer 1b. The printer 1b comprises a management agent MA which processes management requests (e.g., establishment/disconnection of communication sessions for these data transfer channels).

The data transfer channels CH1 and CH2 make data transfer by utilizing an ORB which has dual data descriptors defined in the SBP-3 protocol. The respective channels make data transfer using data buffers designated by two data descriptors. A command block agent CA manages the execution state of an ORB fetched by a fetch agent FA, and execution agents EA0 and EA1 execute predetermined processes, i.e., write or read processes for two data buffers designated by the ORB. The fetch agent sequentially processes ORBs issued by the initiator in accordance with an ordered model of SBP-2/3, thus executing the predetermined processes.

Since SBP-3 is used as the printer control communication command protocol, this embodiment defines a model specification in which data buffers designated by two data descriptors in an ORB are respectively allocated as data transfer channels, so that one data transfer channel is used to transfer print data, and the other data transfer channel is used to transfer a printer control command.

Normally, in SBP-3, upon completion of a process for a data buffer designated by an ORB, the target issues completion status (status block) to the status FIFO address of the initiator as a completion message used to inform the initiator accordingly. However, when two data buffers are designated by two data descriptor fields in an ORB, and completion status (status block) is issued at the time of completion of the two data buffer processes, if access to one data buffer is terminated normally, but access to the other data buffer is not complete, a completion message of that ORB cannot be sent to the initiator, and data transfer as the LUN is delayed. For this reason, if either of the data transfer channels cannot transmit/receive data for some reason or if data transfer in either of the data transfer channels is slower than the other channel, the channel that allows normal or faster transfer is influenced by the other channel.

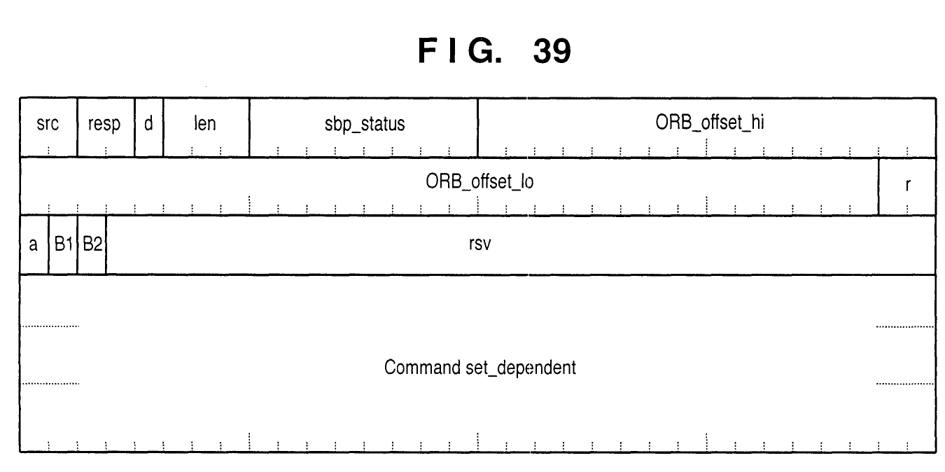

Hence, in this embodiment, access completion for each data buffer can be notified by issuing a status block shown in FIG. 39.

FIG. 39 shows completion status (status block) issued at the time of completion of a data buffer process in the printer control communication command protocol according to this embodiment.

As shown in FIG. 39, in this status block, B1 and B2 are defined as fields indicating completion status for respective data buffers in a command set dependent field.

Upon completion of transfer of one of buffers designated by an ORB, the printer 1b as the target issues a status block by substituting a predetermined value in B1 or B2.

In this way, in data transfer channels allocated to respective buffers, a completion message can be issued irrespective of status of the data transfer process of the other channel.

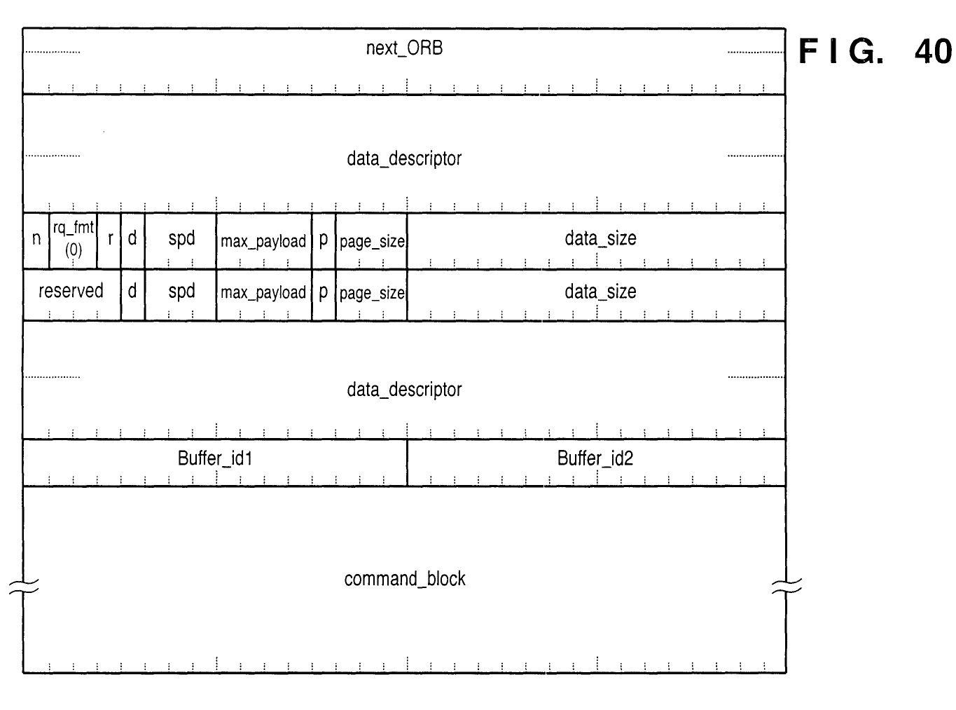

The command protocol of this embodiment defines two ID storage fields in a command block field defined by SBP-3 in an ORB issued by the initiator, as shown in FIG. 40. These fields store IDs appended to data contents for respective data buffers designated by that ORB, and the ID fields are prepared for respective data buffers, i.e., data transfer channels. That is, when the transfer process of a given data buffer is normally terminated during data transfer in a given channel, the ID of a data buffer designated by the next ORB assumes a value incremented by 1.

When a given data buffer is not processed by the target for some reason, and data must be resent, the initiator prepares an ORB appended with the same ID for the corresponding data buffer.

With this function, the target can detect whether new data is transferred from a data buffer designated by an appended ORB or data is resent from a data buffer which has already been designated in the previous ORB list.

Data transfer in the aforementioned system will be described below.

The host 1 as the initiator establishes connection to logical unit LUN0 of the printer 1b as the target 2 to execute a print job.

Upon reception of a communication start request, i.e., a login request from the host, the management agent MA of the printer returns a response that contains a base address as an entry point used to access the fetch agent FA to the initiator as a login response, thus granting the initiator 1 a communication permission.

The host issues a login request to LUN0, and starts a communication after a communication permission is granted.

The host logs in LUN0 of the printer, and assures two data transfer channels using an ORB which comprises dual descriptors on that LUN. One data channel CH1 is used as a two-way channel to transmit a printer control command, and receiving printer status, and the other channel CH2 is used to transmit print data.

Upon instructing the printer to execute a print operation, the initiator issues a print application command that designates the print operation, maps commands required for printer control such as a print application command that inquires of printer status, and the like on a data buffer of CH1, and print data to be actually printed on a data buffer of CH2, prepares an ORB list (a list of three ORBs) which refers to the respective channels on the memory, and appends ORBs. After that, the initiator triggers the fetch agent of the printer to fetch the ORB.

Upon reception of a fetch launch request as access to the ORB pointer, the target fetches an ORB of interest on the basis of pointer information contained in that request using an IEEE1394 read transaction. The target decodes the ORB to recognize based on the value of a request format field (rq_fmt in FIG. 40) that the ORB is of dual descriptor type, and accesses data buffers in accordance with the values of direction bits appended to respective descriptors. In case of CH1, upon transmitting a print command, a write command to the printer is set, i.e., data transfer from the host to the printer is made, and the execution agent executes a process for reading out the data buffer.

On the other hand, upon acquiring printer status, a read command to the printer is set, i.e., data transfer from the printer to the host is made, and the execution agent executes a process for writing in the data buffer. In case of CH2, a write command to the printer upon transmission of print data is set, i.e., data transfer from the host to the printer is made, and the execution agent executes a process for reading out the data buffer.

The printer performs operations based on the read application data. Such operations correspond to transmission of control data from the host to the printer such as transmission of print data and print designation commands, and initialization of a printer device, and transmission of printer status to the host.

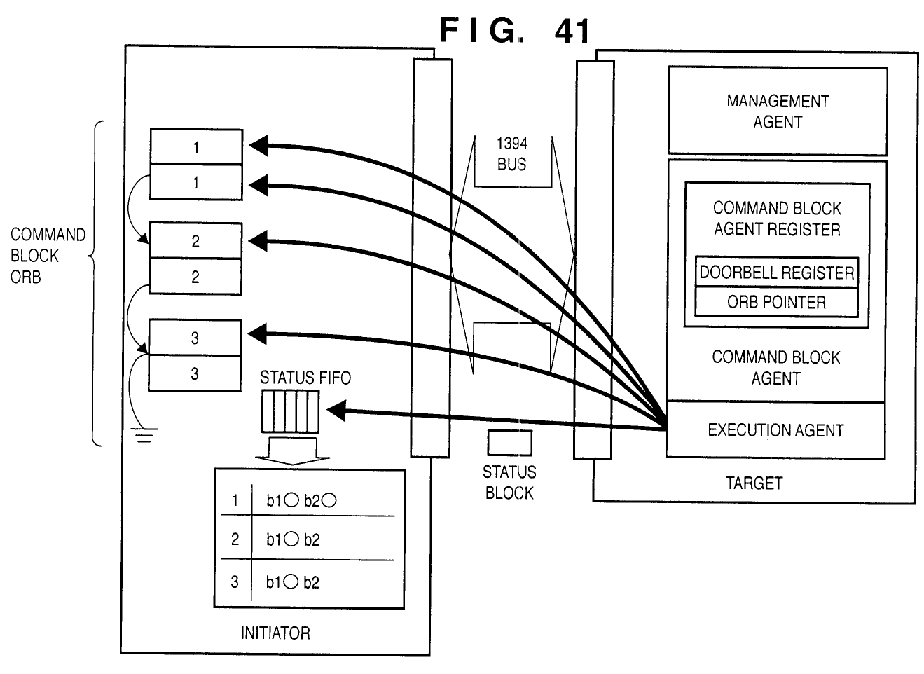

With the above operations, data transfer processes using CH1 and CH2 are executed. However, in some cases, data transfer processes using CH1 and CH2 cannot be executed at the same pace. That is, data buffer transfer using CH1 is complete for a given ORB, but a data buffer process using CH2 is delayed for some reason. The operations in such case will be described below using FIG. 41.

In this case, upon completion of transfer of the buffer on the CH1 side of those designated by an ORB, the target printer issues completion status by substituting a predetermined value indicating completion in a field indicating completion of the corresponding buffer (B1 or B1 in FIG. 39: in this case, B1 since transfer on the CH1 side is complete), which is defined in the status block shown in FIG. 39 in the printer control communication command protocol of this embodiment.

With this status, the initiator can recognize that the data buffer process of CH1 in this ORB is complete but the data buffer process of CH2 is not complete yet. On the other hand, since the target printer can issue a completion message of CH1 irrespective of status of the data transfer process of CH2, it can progress data transfer of CH1 independently of data transfer status of CH2.

If ORBs to be processed still remain in the ORB list, the target printer that issued completion status for a given ORB similarly processes the next ORB. If data transfer of CH2 is still delayed, the target issues a status block to the status FIFO by substituting a predetermined value indicating completion in only B1 as in the above case.

When the target printer has processed the ORB list and has issued a status block for the last ORB, the initiator prepares the next ORB list.

In this case, the initiator re-appends the data buffer of the channel, which is not complete in the status blocks of the previous ORB list, and appends a new data buffer to make next data transfer for the complete channel.

As a result, next data is transferred to the channel that can successfully make data transfer, and identical data is re-transferred to the delayed channel.

An ID corresponding to the appended buffer is appended to the data buffer ID field defined in an ORB in the printer control communication command protocol of this embodiment. In the example of FIG. 41, data transfer to the data buffer on the CH1 (b1) side is successfully made, but data transfer to the data buffer on the CH2 (b2) side is delayed.

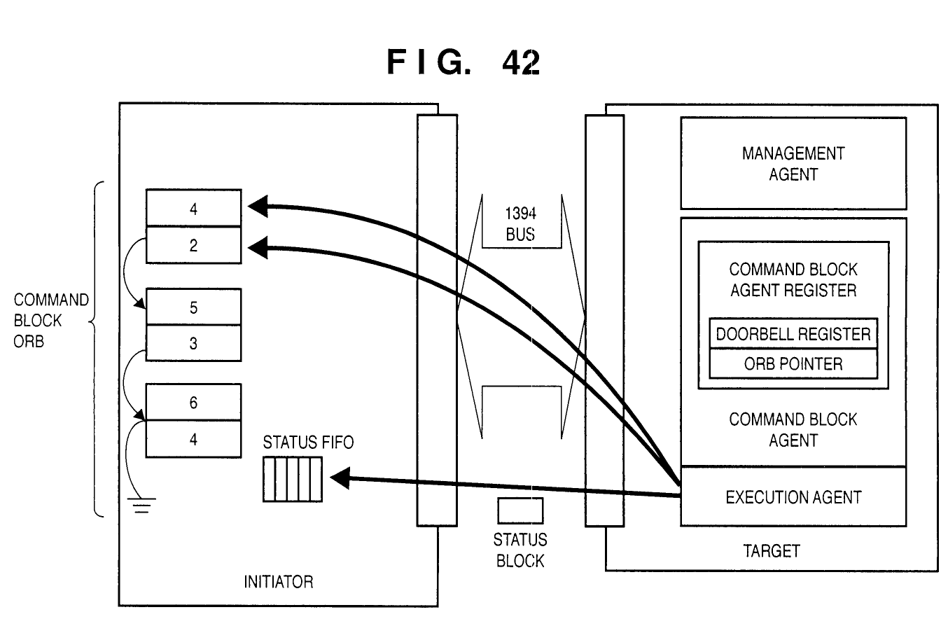

Therefore, the incremented buffer ID is appended to a data buffer for new data in case of CH1, as shown in FIG. 42. In case of CH2, since data after the data buffer, data transfer to which is not complete, must be resent, the corresponding buffer ID is appended as each ID of a data buffer.

When the ORB list is ready, the initiator triggers the fetch agent of the printer to fetch ORBs. After the ORB is fetched, the target printer can recognize by checking the ID fields if a data buffer designated by the appended ORB is a new data buffer or a data buffer which has already been designated in the previous ORB list. The target printer can continue data transfer without repeating a process for the contents of the data buffer of the re-appended channel (CH2) by managing the data buffers using IDs. On the other hand, the channel (CH1) to which a new data buffer is appended successfully makes data transfer. In this manner, CH1 and CH2 can make data transfer based on independent flow control.

(Another Embodiment)

The embodiment of the present invention has been described in detail, and the present invention may be applied to either a system consisting of a plurality of devices or an apparatus made up of a single device. The above embodiment has exemplified a case wherein IEEE1394 is used as a communication control bus. However, the present invention is not limited to such specific bus, and buses of other standards (e.g., USB and the like) may be used.

Note that the present invention includes a case wherein the invention is achieved by directly or remotely supplying a program of software that implements the functions of the aforementioned embodiments to a system or apparatus, and reading out and executing the supplied program code by a computer of that system or apparatus. In this case, software need not have the form of program as long as it has the program function.

Therefore, the program code itself installed in a computer to implement the functional process of the present invention using the computer implements the present invention. That is, the claims of the present invention include the computer program itself for implementing the functional process of the present invention.

In this case, the form of program is not particularly limited, and an object code, a program to be executed by an interpreter, script data to be supplied to an OS, and the like may be used as along as they have the program function.

As a recording medium for supplying the program, for example, a floppy® disk, hard disk, optical disk, magnetooptical disk, MO, CD-ROM, CD-R, CD-RW, magnetic tape, nonvolatile memory card, ROM, DVD (DVD-ROM, DVD-R), and the like may be used.

As another program supply method, the program may be supplied by establishing connection to a home page on the Internet using a browser on a client computer, and downloading the computer program itself of the present invention or a compressed file containing an automatic installation function from the home page onto a recording medium such as a hard disk or the like. Also, the program code that forms the program of the present invention may be segmented into a plurality of files, which may be downloaded from different home pages. That is, the claims of present invention include a WWW server which makes a plurality of users download a program file required to implement the functional process of the present invention by the computer.

Also, a storage medium such as a CD-ROM or the like, which stores the encrypted program of the present invention, may be delivered to the user, the user who has cleared a predetermined condition may be allowed to download key information that decrypts the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

According to the present invention, efficient data transfer can be made using two channels of an IEEE1394 bus or the like.

For example, when SBP-3 is used as a host-printer communication protocol in IEEE1394, a status FIFO for respective ORBs specified in SBP-3 is assured with data buffer execution completion message fields for respective descriptors to notify completion for respective data buffers An initiator appends a new data buffer to only the complete data buffer, and continues data transfer processes for respective ORBs by distinguishing the updated data buffer from the non-updated data buffer, thus implementing a communication protocol which can make data transfer that realizes fully independent flow control for each pair of data buffers (directions).

As a result, when two-channel communications are made using dual descriptors in one logical unit (LUN) of SBP-3, even when one data communication channel goes into a communication disabled state for some reason, the other channel can make transfer without any delay.

As many apparently widely different embodiments of the present invention can be made without departing from the spirit and scope thereof, it is to be understood that the invention is not limited to the specific embodiments thereof except as defined in the appended claims.

What is claimed is:

1. An information processing system including first and second devices,
wherein said first device comprises transmission means for transmitting one request which designates a plurality of data storage areas to said second device,
said second device comprises completion notifying means for notifying said first device of completion of a data communication for one of the plurality of data storage areas, and
in accordance with the notification of completion of the data communication for one of the plurality of data storage areas, said transmission means transmits one request which designates a data storage area, a data communication for which is not complete, and a new data storage area for the data storage area, the data communication for which is complete, to said second device.

2. A communication method between two devices, comprising:
a transmission step of transmitting one request which designates a plurality of data storage areas;
a completion notifying step of notifying completion when a data communication for one of the plurality of data storage areas designated by the request is complete; and
a transmission step of, in accordance with the notification of completion of the data communication for one of the plurality of data storage areas, transmitting one request which designates a data storage area, a data communication for which is not complete, and a new data storage area for the data storage area, the data communication for which is complete.

3. The method according to claim 2, wherein the two devices are connected via a communication control bus complying with IEEE1394.

4. The method according to claim 2, wherein the transmission step includes a step of transmitting a request block which contains a plurality of pieces of identification information respectively indicating the plurality of data storage areas, and commands respectively for the plurality of data storage areas.

5. The method according to claim 2, further comprising a data communication step of writing data on the data storage area designated by the request or reading data from the data storage area designated by the request.

6. An information processing apparatus which can communicate with another device, comprising:
a transmission unit that transmits one request which designates a plurality of data storage areas;
a unit that receives, from the other device, a completion message indicating completion of a data communication for one of the plurality of data storage areas; and
a unit that transmits, on the basis of the completion message, one request which designates a data storage area, a data communication for which is not complete, and a new data storage area for the data storage area, the data communication for which is complete.

7. The apparatus according to claim 6, wherein said transmission unit transmits a request block which contain a plurality of pieces of identification information respectively indicating the plurality of data storage areas, and commands respectively for the plurality of data storage areas.

8. An information processing apparatus which can communicate with another device, comprising:
a unit that receives one request which designates a plurality of data storage areas; and
a completion notifying unit that notifies completion of a data communication for one of the plurality of data storage areas.

9. The apparatus according to claim 8, further comprising data communication unit that transmits data to the other device so as to write data in the data storage area designated by the request or receiving data from the other device so as to read data from the data storage area designated by the request.

10. The apparatus according to claim 9, wherein when data is written in one of the plurality of data storage areas or data is read out from the data storage area, said completion notifying unit notifies completion of a data communication for that data storage area.

11. The apparatus according to claim 1, further comprising a determination unit that determines on the basis of a plurality of pieces of identification information respectively indicating the plurality of data storage areas whether or not a data buffer has been designated by the previously received request.

12. A communication method in an information processing apparatus which can communicate with another device, comprising:
transmitting one request which designates a plurality of data storage areas to the other device;
receiving, from the other device, a completion message indicating completion of a data communication for one of the plurality of data storage areas; and
transmitting, on the basis of the completion message, one request which designates a data storage area, a data communication for which is not complete, and a new data storage area for the data storage area, the data communication for which is complete.

13. A communication method in an information processing apparatus which can communicate with another device, comprising:
receiving, from the other device, one request which designates a plurality of data storage areas;
making a data communication for one of the plurality of data storage areas; and
notifying the other device of completion of a data communication for one of the plurality of data storage areas.
